(19) United States
(12) Patent Application Publication
(10) Pub. No.: US 2011/0215496 A1
(43) Pub. Date: Sep. 8, 2011

(54) INJECTION MOLDING METHOD

(75) Inventors: TORU OGURA, KANAGAWA (JP); HIDETOSHI KAWASAKI, KANAGAWA (JP); HIROKAZU YAGISHITA, KANAGAWA (JP)

(73) Assignee: FUJIFILM CORPORATION, TOKYO (JP)

(21) Appl. No.: 13/040,662

(22) Filed: Mar. 4, 2011

(30) Foreign Application Priority Data
Mar. 4, 2010 (JP) 2010-047678
Mar. 4, 2010 (JP) 2010-047679
Feb. 21, 2011 (JP) 2011-035056
Feb. 21, 2011 (JP) 2011-035057

(51) Int. Cl. B29C 45/76; B29C 45/00

(52) U.S. Cl. 264/40.4; 264/328.1

(57) ABSTRACT

An injection molding method including a measuring step for measuring an amount of the molding material by storing a molding material fed into a cylinder of an injection molding apparatus in a tip of the cylinder by rotation of a screw and stopping a rotation of the screw after the screw is retracted to a measurement set position by a pressure from the stored molding material itself. The measuring step comprises: setting a back pressure to be applied on the screw, to a predetermined value; setting a rotation speed of the screw to a constant rotation speed within a predetermined range; and adjusting a feeding speed of the molding material to a predetermined time so that the measuring time is controlled irrespective of the rotation speed of the screw and the back pressure set value.

### BACKGROUND OF THE INVENTION

1. Field of the Invention

The presently disclosed subject matter relates to an injection molding method, and more particularly to an injection molding method of directly feeding a molding material containing a large amount of powder from a hopper into a cylinder.

2. Description of the Related Art

One typical resin (plastic) molding method is an injection molding method. The injection molding method is a method of filling a resin molding material melted in a heating cylinder (also simply referred to as a cylinder) into a cavity portion of a mold including a male mold and a female mold using a screw or a plunger, and rapidly cooling and then removing the material from the mold to obtain a molded product.

An injection molding cycle generally includes a measuring step, a mold clamping step, an injection step, a dwelling step, a cooling step, and a releasing step.

The measuring step is now described in detail. In the measuring step, a molding material fed into a cylinder is stored in a cylinder tip by rotation of a screw, and the screw receives a pressure from the stored molding material itself and retracts to a predetermined measurement set position, and then the rotation of the screw is stopped to finish measurement. In this case, a normal feeding method is generally performed in which a molding material is filled in an amount surpassing a rotation speed of the screw, that is, a material feeding capacity of the molding material into a hopper, and feeding the material in the hopper into a cylinder so as to fill the cylinder by self-weight of the molding material in accordance with the material feeding capacity of the screw. Thus, when a back pressure set value is constant, a measuring time decreases with increasing rotation speed of the screw, and the measuring time increases with decreasing the rotation speed. In reverse, when the screw rotation speed is constant, the measuring time decreases with decreasing back pressure, and the measuring time increases with increasing back pressure.

As a resin molding material used for injection molding, petroleum resin is conventionally used. However, problems such as air pollution, global heating, or ozone depletion are exposed, and as measures against these problems, attempts to build a circulation type energy saving society are made. As one of the attempts, a molding material is switched from petroleum resin to biological plant resin derived from plants or the like.

A plant resin molding material includes so-called biomass resin (also referred to as biomass plastic or bioplastic), and attempts are made to use the biomass resin as a molding material to produce various products.

Typical examples of biomass resin include polylactic acid (also referred to as polylactic resin or PLA) or cellulose resin. Such biomass resin is expected to provide an advantage that absorption and emission of carbon dioxide are canceled out by each other in the global environment. This idea is called carbon neutral.

However, when biomass resin is used as a molding material to produce a molded product by injection molding, low heat resistance of biomass resin presents a difficulty. Since biomass resin has a smaller difference between a temperature at which biomass resin is thermally melted and can easily flow and a decomposition temperature of the biomass resin than petroleum resin, a temperature set range usable in injection molding or in a machining step as pretreatment of the injection molding is limited to a narrow range. For example, when biomass resin and an additive are kneaded by a kneading machine and pelletized in pretreatment before a molding material is fed to an injection molding apparatus, biomass resin is easily colored or depolymerized if exposed to high heat for long hours. In particular, in order to provide flame retardancy to biomass resin, a large amount of flame retardant (generally, powder) needs to be kneaded into biomass resin, and the biomass resin and the flame retardant are preferably previously pelletized by the kneading machine and then fed to the injection molding apparatus. However, biomass resin is decomposed in heating machining by the kneading machine, thereby reducing strength of a molded product.

Also, biomass resin is fragile, and it is difficult to provide sufficient strength. In particular, a large amount of flame retardant needs to be kneaded into biomass resin as described above, and is further fragile. Thus, when flame retardant is kneaded into biomass resin to ensure flame retardancy, a reinforcing agent needs to be added to increase strength.

Strength of biomass resin can be increased by mixing petroleum resin, but this cannot essentially reduce an environmental load. Another method is adding inorganic fiber such as glass fiber or petroleum organic fiber. This method can provide strength without significantly reducing a bio-content of a molded product, and is preferable. A further method is forming a natural molding material such as bamboo or kenaf fiber into fiber and adding the natural molding material. In this case, fiber parts can be also replaced by carbon neutral materials.

Thus, in order to use biomass resin as a molding material for injection molding, an additive such as flame retardant or fiber is generally added. In view of the low heat resistance of biomass resin, it is preferable for quality of a molded product to adopt direct mixing (referred to as a DM method) in which pretreatment for kneading and mixing biomass resin and an additive to be pelletized is not performed but the biomass resin and the additive are directly fed into an injection molding apparatus for molding.

However, an injection molding apparatus is originally produced for supplying pellets, and has two problems below in a case where, for example, a molding material containing at least a large amount of powder material (including a fine fiber-like molding material corresponding to powder) and a pellet material among the powder material, the pellet material, and a liquid material is directly fed via a hopper of the injection molding apparatus into a cylinder.

A first problem is that when the powder material and the pellet material are to be directly fed, a bridge or the like by compression in the hopper causes clogging at a hopper outlet port or in the cylinder and prevents stable feeding. Even if the materials can be fed, the powder material and the pellet material are easily separated and become nonuniform in the cylinder, and are not sufficiently uniformly kneaded. In particular, when a molding material contains a large amount of powder material, it is difficult to perform uniform kneading by direct mixing. In particular, when a powder ratio of the molding material exceeds 30% by weight, uniform kneading cannot be performed by the conventional injection molding method.

A second problem is that even if, for example, the powder material and the pellet material once mixed by an agitator or the like for directly feeding the powder material and the pellet material are fed to the hopper, the powder material and the pellet material are separated during repeated injection molding by vibration of the injection molding apparatus or a difference in shape or specific gravity of the materials. Thus, a ratio between the powder material and the pellet material fed from the hopper into the cylinder is not as designed, which makes it difficult to stably produce a molded product having uniform quality.

For example, Japanese Patent Application Laid-Open No. 2005-319813 is a technique of solving problems of clogging or degassing of an injection molding apparatus, and for example, Japanese Patent Application Laid-Open No. 2001-277296 is a conventional technique of direct mixing.

Japanese Patent Application Laid-Open No. 2005-319813 describes so-called hungry feeding in which a molding material is constantly fed by a volumetric feeder mechanism rather than by self-weight so as to form a space for separating a gas component (generated from the molding material) in a cylinder of an injection molding apparatus. This allows reliable degassing without clogging of the molding material in the cylinder, thereby allowing a molded product having high quality to be stably produced.

Japanese Patent Application Laid-Open No. 2001-277296 proposes that base resin is fed by self-weight into a cylinder of an injection molding apparatus, while an additive is directly fed to a screw portion. This apparatus has characteristics in that the additive is continuously fed not only in a measuring step but also in an injection step or a dwelling step. Specifically, noting that the base resin is fed also in the injection step, and the additive is fed also in the injection step as supplement thereof. Thus, uneven concentration of the additive in a cylinder length direction in the cylinder can be improved.

### SUMMARY OF THE INVENTION

However, even if the technique of Japanese Patent Application Laid-Open No. 2005-319813 is applied to injection molding, particularly, direct mixing of a molding material containing biomass resin and an additive (flame retardant, fiber, or the like), a molded product having high quality cannot be obtained. Japanese Patent Application Laid-Open No. 2005-319813 is originally for feeding pellets into the cylinder, and when a large amount of powder or fiber is fed as a molding material, uniform kneading cannot be performed even if the material is directly fed from a hopper into the cylinder, and a molded product having stable quality cannot be obtained.

For comparison, in Japanese Patent Application Laid-Open No. 2001-277296, at the same time when the resin pellets are naturally fed by gravity, the additive is measured and added. Besides, only for the additive, the measured addition is continuously performed during when the screw works without rotation such as during the injection step, as well as the measuring step, thereby the amount (unevenness) of the additive in the molded product is stabilized. In this method, the additive is fed even in a state where the screw advances without rotation such as in the injection step, which enables to reduce deviation of the additive concentration and color unevenness of colorant, compared with the conventional method.

However, during when the screw is advancing, for example, during the injection step, the feeding amount of resin pellets deviates unlike during the measuring step. Therefore, it is impossible to control the ratio of resin pellets falling by gravity and the additive measured and fed. Further, because retention (detention) of materials in a material inlet port (a portion C2 in FIG. 1 of the Japanese Patent Application Laid-Open No. 2001-277296) tends to be large, the materials easily separate again. Especially when, an additive ratio in the molding material, that is, a powder material ratio is large, or when an apparent specific gravity of the power material is small, like the present invention, it is impossible to sufficiently homogenize the molding material.

In fact, when the techniques of Japanese Patent Application Laid-Open Nos. 2005-319813 and 2001-277296 are applied to perform injection molding of a molding material containing a large amount of powder additive in pellet-like biomass resin by direct mixing and an obtained molded product is tested, the additive is not uniformly dispersed in the biomass resin, and a molded product having intended quality cannot be obtained.

From such background, because actually, biomass resin and an additive must be previously kneaded by a kneading machine to be formed as a pellet, and the pellet must be fed into an injection molding apparatus for molding.

However, as described above, biomass resin has low heat resistance, when high heat is applied in the pretreatment by the kneading machine, the molding material is deteriorated and reduced in molecular weight or colored, before being fed into the injection molding apparatus. Thus, even if the molding material can be machined into a pellet suitable for the injection molding apparatus, the molecular weight of the resin is reduced and strength of the molded product cannot be provided, or the molded product is colored and reduced in quality.

The presently disclosed subject matter is achieved in view of such circumstances, and has an object to provide an injection molding method that can prevent clogging and uniformly knead a molding material in a cylinder even in a case where a molding material, particularly, a molding material containing at least a powder material and a pellet material among the powder material, the pellet material, and a liquid material is directly fed via a hopper of an injection molding apparatus into a cylinder for injection molding, and thus can stably produce a molded product having high quality even if, for example, biomass resin having low heat resistance is used as base resin.

In order to achieve the object, the presently disclosed subject matter provides an injection molding method including a measuring step for measuring an amount of the molding material by storing a molding material fed into a cylinder of an injection molding apparatus in a tip of the cylinder by rotation of a screw and stopping a rotation of the screw after the screw is retracted to a measurement set position by a pressure from the stored molding material itself, wherein the measuring step comprises: setting a back pressure to be applied on the screw, to a predetermined value; setting a rotation speed of the screw to a constant rotation speed within a range of 50 to 300 rpm; and adjusting a feeding speed of the molding material fed into the cylinder so that a measuring time becomes twice SN seconds or more and 180 seconds or less, the SN indicating a measuring time in a normal feeding method in which the molding material is fed from an inlet port into the cylinder to fill the cylinder by self-weight of the molding material in accordance with a material feeding capacity of the rotation speed of the screw, whereby the measuring time is controlled irrespective of the rotation speed of the screw and the back pressure set value.

Here, the feeding speed of the molding material is a feeding amount of the molding material per unit time.

According to the presently disclosed subject matter, the measuring time is not determined by the rotation speed of the screw, that is, the material feeding capacity of the molding material in the cylinder or the back pressure set value as is conventional, but the feeding speed of the molding material is adjusted irrespective of the rotation speed of the screw and the back pressure set value, and thus the measuring time is controlled irrespective of the feeding capacity of the screw and the back pressure set value (hereinafter referred to as “measuring time control”). Specifically, in the measuring time control, when the back pressure is set to a predetermined value, the rotation speed of the screw is set to a constant rotation speed of 50 to 300 rpm at which high kneading performance can be obtained, and the feeding speed of the molding material fed into the cylinder is adjusted so that the measuring time becomes twice the measuring time SN or more and 180 seconds or less, the SN being the measuring time in the normal feeding method in which the cylinder is filled with the molding material.

The rotation speed of the screw is more preferably 150 to 200 rpm, and the measuring time is more preferably 5 to 20 times the measuring time SN.

Thus, the screw can be rotated at a rotation speed suitable for kneading, and a long measuring time can be taken. Thus, for example, even when a molding material composed of a large amount of powder, fiber and so on, is directly fed into the cylinder, a rotation speed of the screw or a required kneading time required for uniformly kneading the molding material can be sufficiently ensured.

In this case, the rotation speed of the screw is set to 50 to 300 rpm in view of both improvement in kneading performance and deterioration by shear heating. The back pressure set value may be set to a desired value, and preferably 5 to 150 kg/cm².

Further, the long measuring time can be taken irrespective of the rotation speed of the screw and the back pressure set value, and thus a feeding amount of the molding material can be significantly reduced compared with the material feeding capacity of the screw. Thus, even if, for example, a molding material containing powder that easily causes a bridge or clogging is directly fed into the cylinder, the bridge or clogging is not caused.

In the presently disclosed subject matter, it is preferable that when the inside of the cylinder is divided into three zones: a feeding zone, a compression zone, and a measuring zone in this order from the inlet port of the molding material, a space before at least the compression zone is not filled with the molding material.

The fact that “the cylinder is not filled with the molding material” means that the molding material is conveyed in a loose state (sparse state) rather than a tight state (dense state) in the cylinder, and a case where the tight state and the loose state are alternately formed in the cylinder is also included.

This specifies fullness of the molding material in the cylinder. The space before at least the compression zone is not filled with the molding material, and thus also in the compression zone that is a particularly important zone for uniform kneading, an amount of fed material is reduced, and it takes a long time to generate back pressure required for retraction of the screw. Specifically, required kneading and dispersion times can be sufficiently ensured. In this case, at a start of injection molding, “the state where the space before at least the compression zone is not filled with the molding material” is created, and in this state, the molding material is added from a volumetric feeding device at a feeding speed lower than that for an average consumption amount of the molding material in the normal feeding method. Thus, the state where the cylinder is not filled with the molding material at the start of the injection molding can be maintained after continued injection molding.

In particular, for a molding material containing a large amount of powder, the molding material around a screw shaft remains unmelted in the compression zone, and tends to be wound around the screw shaft and fed to the measuring zone. Thus, the molding material that is not sufficiently uniformly kneaded reaches the measuring zone, thereby reducing quality of an injected molded product.

In the presently disclosed subject matter, the measuring time is made to be twice the measuring time SN or more in the normal feeding method and 180 seconds or less, thus the feeding amount of the molding material can be reduced with respect to the material feeding capacity of the molding material by the rotation speed of the screw. Thus, the fullness of the molding material in the compression zone is reduced to prevent excessive shear heating, and a long kneading time can be taken. Thus, even a molding material containing a large amount of powder can be uniformly kneaded.

In the presently disclosed subject matter, the measuring time is preferably controlled in accordance with the required kneading time of the molding material. The required kneading time of the molding material is, as described above, a time required for the molding material to be uniformly kneaded in the cylinder, and can be calculated by a preliminary test or the like. However, when the required kneading time exceeds 180 seconds described above, the required kneading time is set to 180 seconds.

In the presently disclosed subject matter, the measuring time is preferably controlled according to a time from a start of a cooling step to a finish of a releasing step of the injection molding cycle. Thus, there is no need to provide a time (waiting step) when the rotation of the screw is stopped from the start of the cooling step to the finish of the releasing step. Thus, the molding material can be sufficiently kneaded, and uneven heating of the molding material by the stop of the screw can be prevented.

The presently disclosed subject matter may be applied to a molding material in a form of a pellet, but it is preferable that the molding material contains base resin and an additive, at least one of the base resin and the additive is powder, and the molding material not pelletized is directly fed into the cylinder. In particular, it is preferable that the base resin is at least one of polylactic resin and cellulose resin, and the additive is at least one of flame retardant and fiber. In this case, a ratio of biomass resin in the molding material is preferably 30% by weight or more, and particularly preferably 50% by weight or more. This can contribute to reduce an environmental load.

The fact that the molding material is directly fed into the cylinder means that pretreatment machining is not performed in which the molding material is previously kneaded by a kneading machine or the like and then pelletized.

In the case where biomass resin having low heat resistance and an additive in a form of powder or fiber (for example, flame retardant or fiber) that is added in a large amount and difficult in uniform kneading are directly fed into the cylinder for injection molding, a molded product having high quality can be stably produced.

A ratio of the powder in the molding material is preferably 30% by weight or more, because the presently disclosed subject matter is particularly effective with such a high powder ratio. The powder ratio is particularly preferably 50% by weight or more.

In the presently disclosed subject matter, it is preferable that a small amount of molding material is continuously fed into the cylinder or the molding material is intermittently fed into the cylinder to adjust the feeding speed.

This can reduce the feeding speed, and easily equalize the feeding speed, thereby preventing variations in kneading in the measuring step.

In the presently disclosed subject matter, it is preferable that the molding material is a molding material containing at least a powder material and a pellet material among the powder material, the pellet material, and a liquid material, one injection shot of each of the materials is fed into the cylinder using separate measuring feeders so that feeding time periods from a start to a finish of feeding are synchronized 60% or more, and the feeding is finished within a measuring time in the measuring step of the injection molding cycle.

In addition to the “measuring time control”, “synchronous feeding” in which the materials are synchronized 60% or more is thus performed. Thus, even if the molding material contains a high ratio of powder, more uniform kneading can be performed.

In order to achieve the object, the presently disclosed subject matter provides an injection molding method in which a molding material containing at least a powder material and a pellet material among the powder material, the pellet material, and a liquid material is directly fed into a cylinder of an injection molding apparatus for injection molding, including the steps of: feeding one injection shot of each of the materials into the cylinder using separate measuring feeders so that feeding time periods from a start to a finish of feeding are synchronized 60% or more; and finishing the feeding within a measuring time in the measuring step of an injection molding cycle.

This aspect takes the “synchronous feeding” described above as one characteristic, and the advantage of the presently disclosed subject matter can be achieved by only performing the synchronous feeding without performing measuring time control.

The powder material includes fine fiber or the like corresponding to powder, and the pellet material includes a granular material having a larger size than powder.

According to the synchronous feeding in the injection molding method of the presently disclosed subject matter, one injection shot of each of the molding material at least containing the powder material and the pellet material is fed by the separate measuring feeders so that the feeding time periods from the start to the finish of feeding are synchronized 60% or more (hereinafter referred to as “synchronous feeding”). The feeding time periods are more preferably synchronized 90% or more. Thus, the feeding time periods are synchronized 60% or more, and thus the molding material can be uniformly kneaded in the cylinder even if the molding material contains such as the powder material and the pellet material having different shapes or specific gravities. The fact that the feeding time periods of the materials are synchronized 60% or more means that an overlapping part of the feeding time periods of the materials is 60% or more.

In Japanese Patent Application Laid-Open No. 2001-277296 as a conventional technique, an additive measured and added simultaneously with a resin pellet is continuously measured and added to a resin pellet naturally fed by gravity in a measuring step when a screw is not rotated but operated other than during measurement (for example, in an injection step), thereby stabilizing an amount of additive (unevenness) in a molded product. With this method, the additive is fed even in a state where the screw is not rotated but advanced as in the injection step, and variations in additive concentration or color unevenness of a colorant can be reduced as compared with conventional methods.

However, for example, during advancing of the screw in the injection step, a feeding amount of the resin pellet changes unlike in the measuring step. Thus, a ratio between the resin pellet dropped by gravity and the additive constantly fed cannot be controlled. Further, a large amount of material tends to be accumulated at a material inlet port (part C2 in FIG. 1 in Japanese Patent Application Laid-Open No. 2001-277296), and the material is easily separated again. In particular, as in the presently disclosed subject matter, when an additive ratio, that is, a powder material ratio of the molding material is high, or an apparent specific gravity of the powder material is low, the molding material cannot be sufficiently made uniform.

In contrast to this, in the presently disclosed subject matter, the additive is fed in accordance with feeding of the resin pellet, and a ratio between the additive and the resin pellet can be constantly maintained. A level sensor of the molding material is provided immediately close to (immediately above) the screw, thereby reducing an amount of accumulated molding material. This prevents nonuniform separation of the molding material before substantially fed into the screw, and allows a stable injection molded product to be obtained.

Thus, according to the presently disclosed subject matter, even if the materials such as the powder material and the pellet material having different shapes or specific gravities are directly fed via the hopper into the cylinder, the ratio between the powder material and the pellet material is easily as designed, thereby allowing a molded product having uniform quality to be stably produced.

It is further preferable that the measuring time control described above is combined with the “synchronous feeding” in the presently disclosed subject matter as described above. Also in the “synchronous feeding”, it is preferable that the molding material contains base resin and an additive, the base resin is at least one of polylactic resin and cellulose resin, and the additive is at least one of flame retardant and fiber.

According to the injection molding method of the presently disclosed subject matter, the measuring time control is performed, and thus even if the molding material, particularly, the molding material containing a large amount of powder is directly fed into the injection molding apparatus by direct mixing, clogging can be prevented, and the molding material can be sufficiently uniformly kneaded in the cylinder.

According to the injection molding method of the presently disclosed subject matter, the synchronous feeding is performed, and thus even if the molding material containing at least the powder material and the pellet material among the powder material, the pellet material, and a liquid material is directly fed via the hopper of the injection molding apparatus into the cylinder for injection molding, the molding material can be uniformly kneaded in the cylinder.

Thus, even if biomass resin having low heat resistance is used as base resin, a molded product having high quality can be stably produced.

Further, the measuring time control and the synchronous feeding can be combined to provide a greater advantage.

### BRIEF DESCRIPTION OF THE DRAWINGS

FIG. 1 is a schematic configuration diagram of an injection molding apparatus that carries out an injection molding method according to a first embodiment of the presently disclosed subject matter;

FIG. 2 illustrates a zone configuration of the injection molding apparatus;

FIG. 3 illustrates a general injection molding cycle;

FIG. 4 illustrates a general relationship between a back pressure increase rate and a screw rotation speed;

FIG. 5 illustrates behavior in a compression zone when a molding material containing 100% pellet is injection molded;

FIG. 6 illustrates behavior in the compression zone when a molding material containing 30% by weight or more powder is injection molded;

FIGS. 7A to 7C illustrate positions of a screw in a measuring step of the presently disclosed subject matter;

FIG. 8 is a schematic configuration diagram of an injection molding apparatus that carries out an injection molding method according to a second embodiment of the presently disclosed subject matter;

FIG. 9 illustrates synchronous feeding;

FIG. 10A is a table showing injection conditions and results in examples in Test A;

FIG. 10B is a table showing injection conditions and results in comparative examples in Test A;

FIGS. 11A and 11B are photographs respectively showing a comparison of an adhesion state of a powder material to a screw shaft between an example and a comparative example in Test A;

FIG. 12A is a table showing injection conditions and results in examples in Test B;

FIG. 12B is a table showing injection conditions and results in comparative examples in Test B;

FIG. 13A illustrates normal feeding;

FIG. 13B illustrates hungry feeding;

FIG. 13C illustrates “scattering feeding” in the presently disclosed subject matter;

FIG. 13D illustrates a further advanced state of the “scattering feeding” in the presently disclosed subject matter;

FIG. 13E illustrates an extreme state of the “scattering feeding” in the presently disclosed subject matter; and

FIG. 14 is a table of examples and comparative examples in Test C.

### DETAILED DESCRIPTION OF THE PREFERRED EMBODIMENTS

Now, preferred embodiments of an injection molding method of the presently disclosed subject matter will be described with reference to the accompanying drawings. Further, the numerical range expressed by using “to” in the present description means the range including the numerical values described before and after “to”.

### First Embodiment

A first embodiment of the presently disclosed subject matter is the invention relating to measuring time control in the injection molding method.

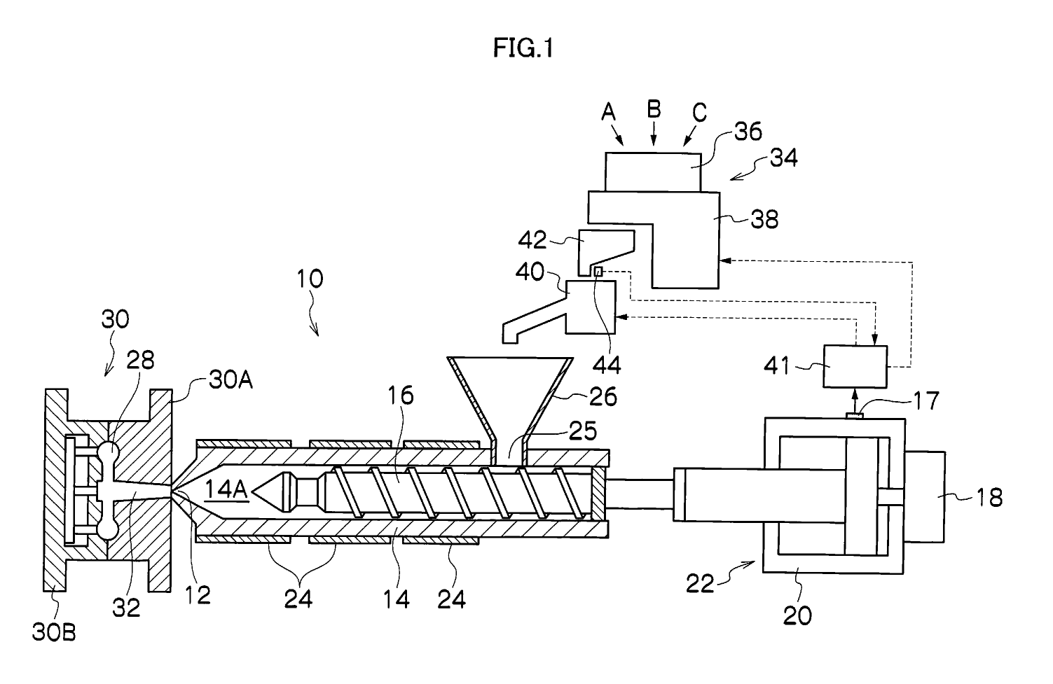

FIG. 1 is a schematic configuration diagram of an example of an injection molding apparatus that carries out the injection molding method of the presently disclosed subject matter.

As shown in FIG. 1, the injection molding apparatus 10 includes a cylinder 14 having a nozzle 12 at a tip, and a screw 16 is rotatably provided in the cylinder 14. At an end opposite to the nozzle 12 and a rear end of the screw 16, a motor/piston device 22 is provided including a motor 18 that rotates the screw 16 and a piston device 20 that advances and retracts the screw 16 in an axial direction (a lateral direction in FIG. 1) at a constant stroke based on set values of pressure and speed. The piston device 20 causes the screw 16 to advance leftward in FIG. 1 to perform an injection operation. In the piston device 20, a back pressure sensor 17 is provided for detecting back pressure which makes the screw 16 retract in a measuring step, and a measured value is input to a controller 41 described later. To the controller 41, measurement signals that notify of a start and a finish of the measuring step are input from the motor/piston device 22.

A heater 24 is wound around an outer periphery of the cylinder 14, and the cylinder 14 is heated to a predetermine temperature based on a melting temperature (plasticizing temperature) or the like of a molding material to be injection molded. The tip of the nozzle 12 is connected to a gate 32 of a mold 30 that forms a cavity 28 therein. The mold 30 includes a stationary mold 30A and a movable mold 30B, and the movable mold 30B is opened and closed with respect to the stationary mold 30A.

In a length direction of the cylinder 14, an inlet port 25 that feeds base resin and an additive or the like as a molding material into the cylinder 14 is formed at the end opposite to the nozzle 12, and a hopper 26 is mounted to the inlet port 25.

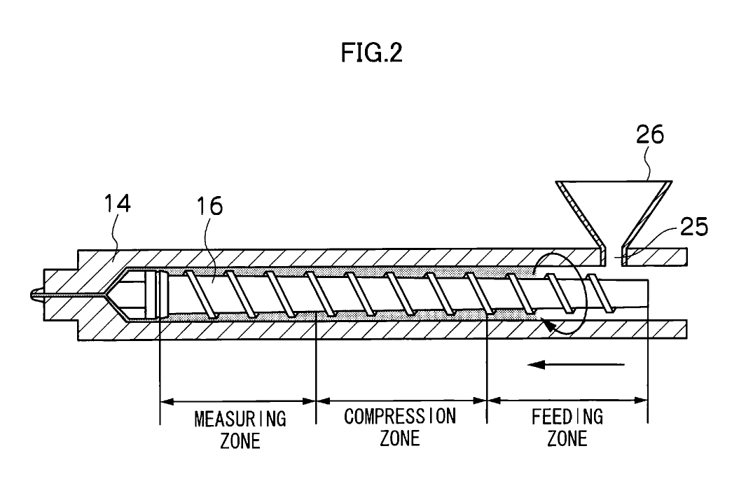

As shown in FIG. 2, the inside of the cylinder 14 is divided into three zones: a feeding zone, a compression zone, and a measuring zone in this order from the inlet port 25 of the molding material. The molding material fed from the hopper 26 through the inlet port 25 into the feeding zone is conveyed to a tip side of the screw in the cylinder 14 by rotation of the screw 16. The molding material conveyed in the cylinder 14 is gradually melted by shear heat generated between a surface of the rotating screw 16 and an inner surface of the cylinder 14, and heat from the heater 24 provided around the outer periphery of the cylinder 14. In the compression zone, melting and kneading of the molding material is started. Molded resin melted and kneaded in the compression zone is further conveyed forward and reaches the measuring zone. As the melted and kneaded molding material is accumulated in the tip of the cylinder 14, the screw 16 is retracted, and when the screw 16 reaches a measurement set position, the retraction is stopped.

A material feeding device 34 mainly includes a mixer 36 that mixes, for example, the base resin and the additive that constitute the molding material, a granular material volumetric feeder 38, a measurement control feeder 40, and a controller 41 that controls feeding of the molding material. The mixer 36 may include an agitation mixer, a vibration mixer, an air flow mixer, or the like that can uniformly mix the base material and the additive. The granular material volumetric feeder 38 includes a table feeder, a belt feeder, a screw feeder, a rotary feeder, a bin discharger, a circle feeder, or the like, which are appropriately used depending on a property of the molding material.

The molding material containing the base resin and the additive mixed in the mixer 36 is cut in a predetermined amount by the granular material volumetric feeder 38. The cut molding material is fed via a shooter 42 to the measurement control feeder 40. A sensor 44 is provided in the measurement control feeder 40, and the sensor 44 detects whether the molding material is stored in the measurement control feeder 40 and transmits the result to the controller 41. The controller 41 feeds a constant amount of molding material required for one cycle of the measuring step from the granular material volumetric feeder 38 to the measurement control feeder 40 in a time period when the measurement control feeder 40 is on standby, that is, a time period when no molding material is stored in the measurement control feeder 40.

Required kneading time data for the molding material to be uniformly and sufficiently kneaded is input to the controller 41 depending on various factors such as a type of the molding material (a type of resin, a type of an additive, or the like), a shape of the material (powder, granule, liquid, pellet), a mixing ratio (a ratio between the base resin and the additive), an injection molding condition (an injection amount of one shot, a heating temperature of the cylinder, a rotation speed of the screw, a back pressure set value, or the like). The required kneading time data can be previously obtained by a preliminary test or the like. Also, a relationship between a measuring time for ensuring a required kneading time and a feeding speed of the molding material from the measurement control feeder 40 is input to the controller 41.

The controller 41 sets the back pressure to a predetermined value and sets the rotation speed of the screw 16 to a constant rotation speed within a range of 50 to 300 rpm. Meanwhile, when a measuring time in a normal feeding in which the molding material is fed from the inlet port 25 into the cylinder 14 so as to fill the cylinder 14 by self-weight in accordance with a material feeding capacity of the screw rotation speed is SN seconds, the controller 41 adjusts the feeding speed of the molding material fed into the cylinder 14 so that a measuring time becomes twice SN seconds or more and 180 seconds or less. Specifically, the controller 41 adjusts the feeding speed of the molding material fed from the measurement control feeder 40 via the hopper 26 into the cylinder 14 irrespective of the rotation speed of the screw 16 and the back pressure set value, thereby the controller 41 controls the measuring time in the measuring step in the range of twice SN to 180 seconds in accordance with the required kneading time of the molding material (“measuring time control”). A more preferable measuring time in the measuring time control is 5 to 20 times SN seconds.

Thus, the screw 16 can be rotated at a rotation speed suitable for kneading, and a long measuring time can be taken. Thus, for example, when a molding material containing a large amount of powder or fiber is directly fed into the cylinder, a screw rotation speed or a required kneading time required for uniformly kneading the molding material can be sufficiently ensured.

In this case, the rotation speed of the screw is preferably set to 50 to 300 rpm in view of both improvement in kneading performance and deterioration by shear heating. More preferably, the rotation speed of the screw is set to 150 to 200 rpm. At a screw rotation speed less than 50 rpm, uniform kneading cannot be sufficiently performed, and at a screw rotation speed more than 300 rpm, shear heating may deteriorate the molding material. In particular, when the base resin of the molding material is biomass resin, a screw rotation speed more than 300 rpm is highly likely to deteriorate the molding material.

When the feeding speed of the molding material fed into the cylinder is set so that the measuring time becomes less than twice SN, the SN being the measuring time in the normal feeding method in which the cylinder is filled with the molding material, uniform kneading cannot be performed. Meanwhile, when the measuring time is increased to exceed 180 seconds, uniform kneading can be performed but depolymerization by decomposition of the base resin occurs to reduce strength of a molded product obtained by injection molding. Thus, if a required kneading time obtained by a preliminary test exceeds 180 seconds, the required kneading time is preferably set to 180 seconds.

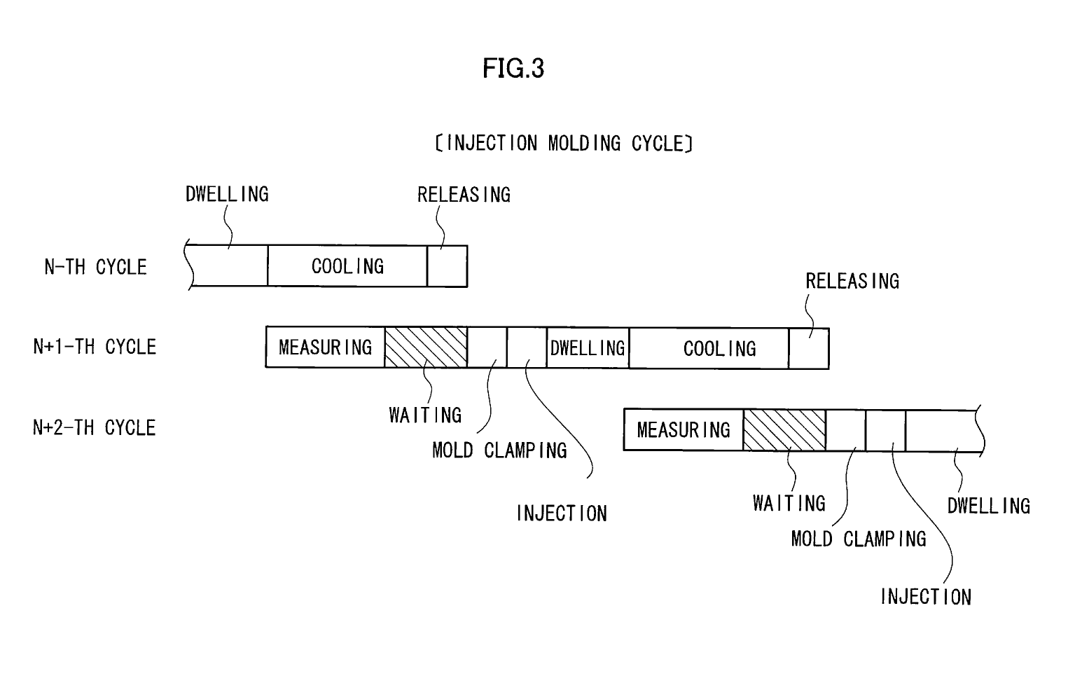

Now, an injection molding cycle of the injection molding apparatus will be described with reference to FIG. 3.

The injection molding cycle generally includes a measuring step, a mold clamping step, an injection step, a dwelling step, a cooling step, and a releasing step.

In the measuring step (also referred to as a plasticizing step), the molding material fed from the hopper 26 into the heated cylinder 14 is kneaded and melted (plasticized) by rotation of the screw 16 and pressure fed, and the melted molding material is stored in a cylinder tip 14A. The screw 16 is rotated and retracted by a pressure received from the stored molding material itself, and when a preset measured value is reached, the rotation of the screw is stopped to finish measurement. A time required for the measuring step is referred to as a measuring time.

In the mold clamping step, the mold 30 including the movable mold 30B and the stationary mold 30A in an opened state is closed, and a mold clamping cylinder (not shown) moves the movable mold 30B toward the stationary mold 30A so as to abut against the stationary mold 30A, thereby closing the mold 30.

In the injection step (also referred to as a filling step), the molding material melted in the cylinder 14 into a liquid state is injected through the nozzle 12 into the mold 30 by advancing of the screw 16. Thus, the melted molding material is filled into the cavity 28 in the mold 30.

In the dwelling step, the screw 16 applies pressure into the cavity 28 even after the melted molding material is filled into the cavity 28 in the mold 30 in the injection step. Thus, the molding material in the cavity 28 is formed into the shape of the cavity.

In the cooling step, the molding material is cooled and solidified so that the molded product has sufficient rigidity when released from the mold.

In the releasing step, the mold clamping cylinder moves the movable mold 30B in a direction away from the stationary mold 30A to open the mold 30. Thus, the molded product is released from the mold 30.

In the above-described steps, the screw 16 is freely movable after completion of dwelling. Thus, as shown in FIG. 3, a measuring step in an n+1-th cycle is overlapped with a cooling step in an n-th cycle as much as possible to increase efficiency of a molding cycle.

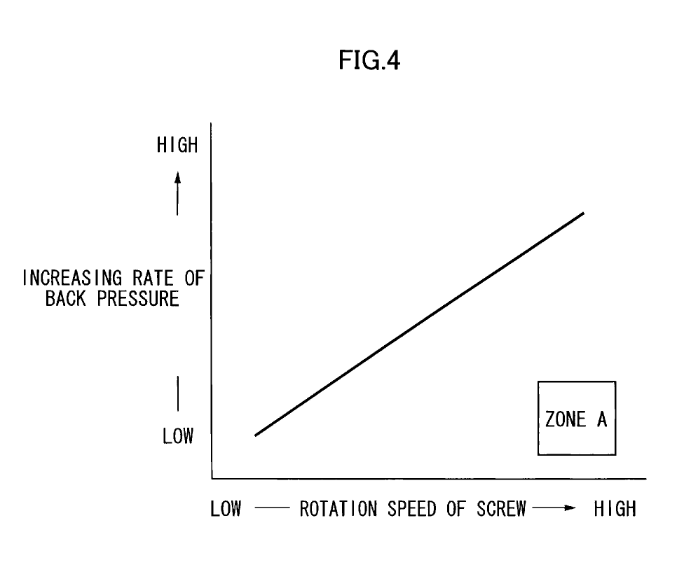

FIG. 4 illustrates a general relationship between a back pressure increase rate and the rotation speed of the screw 16 in the measuring step described above. As is apparent from a straight line rising steadily from left to right in FIG. 4, the back pressure increase rate increases with increasing rotation speed of the screw 16. Thus, if the rotation speed of the screw 16 is increased to increase a shear force on the molding material, the back pressure increases in a short time, and the measuring step is finished. Thus, a long time for kneading the molding material cannot be ensured.

On the contrary, if the rotation speed of the screw 16 is reduced, the time required to increase the back pressure can be extended to ensure a long kneading time. However, since the rotation speed of the screw 16 is low, a shear force for sufficient kneading cannot be applied to the molding material.

Thus, in the conventional injection molding method in which the measuring time in the measuring step is determined with reference to the rotation speed of the screw 16 and the back pressure set value, a long kneading time cannot be ensured. When a cooling time required in the cooling step is longer than the measuring time in the measuring step, as shown in the injection molding cycle in FIG. 3, a waiting step after the finish of the measuring step is required between the measuring step and the mold clamping step. The waiting step is a state where the measuring step is finished and the screw 16 is stopped, and thus waiting is performed with the kneading being stopped. Thus, there is a possibility that the kneading time of the molding material cannot be sufficiently ensured, and the screw 16 is stopped to unevenly heat the molding material, thereby easily causing plastic distribution.

In particular, for a molding material such as biomass resin that requires addition of a large amount of additive such as flame retardant or fiber to improve quality, the material needs to be sufficiently agitated and kneaded in the measuring step, and it is important to make full use of the time from the start of the cooling step to the finish of the releasing step for kneading.

Thus, if the back pressure increase rate is low although the rotation speed of the screw 16 is high as in a zone A in FIG. 4, both the high shear force and the kneading time can be satisfied.

Thus, as described above, in the injection molding method of the presently disclosed subject matter, the feeding speed of the molding material from the hopper 26 into the cylinder 14 is adjusted irrespective of the rotation speed of the screw 16 and the back pressure set value to control the measuring time in accordance with the required kneading time.

Specifically, when the factors such as the type of the molding material or the molding condition are input to the controller 41, the controller 41 selects a measuring time required for the molding material from input required kneading time data. The controller 41 also calculates a feeding speed of the molding material for one cycle stored in the measurement control feeder 40 so that the measuring time from the start to the finish of the measurement is the required kneading time, and sets the feeding speed to the measurement control feeder 40. Thus, the measurement control feeder 40 feeds the molding material for one cycle via the hopper 26 into the cylinder 14 based on the calculated feeding speed.

For example, when the required kneading time required for uniformly and sufficiently kneading biomass resin and an additive (flame retardant and glass fiber) is 20 seconds, the feeding speed of the molding material for one cycle stored in the measurement control feeder 40 is controlled so that the measuring time in the measuring step is at least 20 seconds or more. In this case, the feeding speed from the start to the finish of the measuring step is preferably as equal as possible. Thus, it is preferable to adopt a small amount continuous feeding method (scattering feeding) of continuously dropping a small amount of molding material from the measurement control feeder 40 onto the hopper 26 in a scattering manner, or an intermittent feeding method of intermittently dropping a constant amount of molding material from the measurement control feeder 40 onto the hopper 26 at regular intervals.

Thus, the screw 16 can be rotated at high speed suitable for kneading, and also a long measuring time when the screw 16 is rotationally operated can be taken. Thus, even if, for example, a molding material containing a large amount of powder or fiber is directly fed into the cylinder 14, sufficient kneading can be performed.

The long measuring time can be taken irrespective of the rotation speed of the screw 16, and thus even if the molding material containing powder is directly fed into the cylinder 14, the material feeding capacity of the screw 16 is definitely higher as compared with the feeding speed of the molding material. This prevents clogging of the molding material at an outlet port of the hopper 26 or in the cylinder 14.

In particular, when the powder ratio of the molding material is 30% by weight or more, the injection molding method of the presently disclosed subject matter can be performed to allow uniform kneading, and allow injection molding without clogging of the molding material at an outlet port of the hopper 26 or in the cylinder 14.

Specifically, even when a molding material containing such as petroleum resin having high heat resistance and a powder material as an additive, the molding material can be pelletized by the kneading machine as pretreatment of injection molding, and thus all the molding material in a pellet state can be fed into the cylinder 14. However, when a molding material containing such as biomass resin having low heat resistance and a large amount of powder material as an additive, the molding material cannot be pelletized by the kneading machine as pretreatment of injection molding, and thus the large amount of additive in a form of powder is directly fed into the cylinder 14.

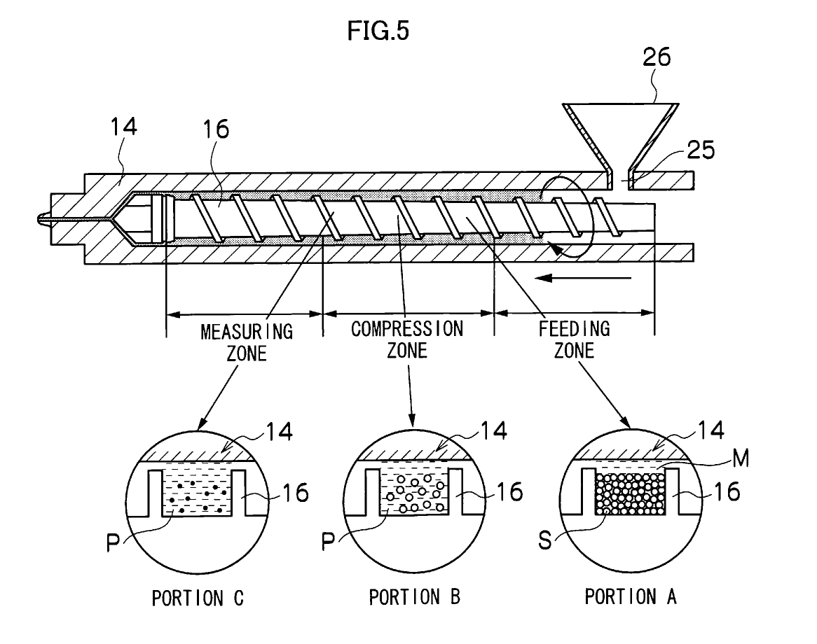

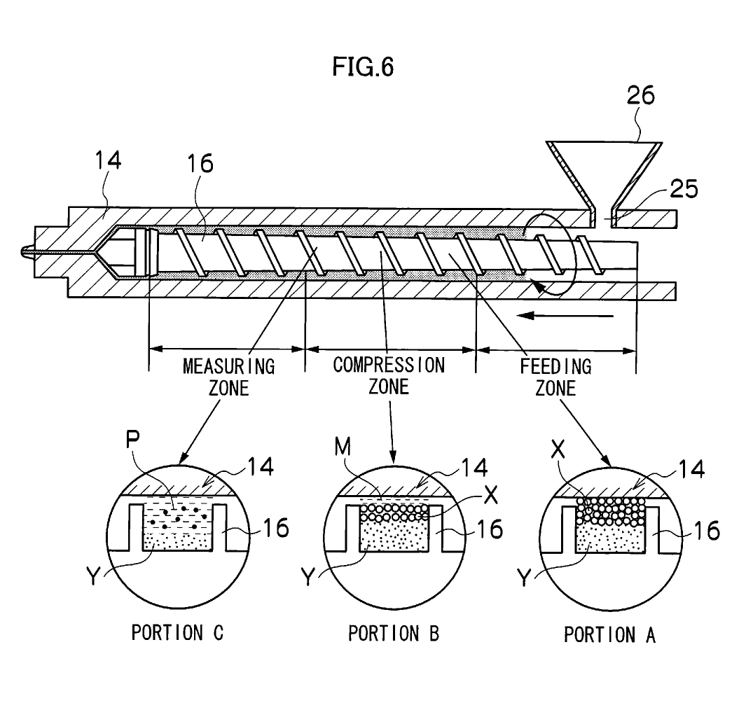

Melting behavior of the molding material in the compression zone is completely different between when a molding material containing 100% pellet is directly fed into the cylinder 14 (DM method), and when a molding material containing 30% by weight or more powder, particularly, 50% by weight or more powder is directly fed into the cylinder 14 (DM method). Specifically, most of the powder material (including fiber material) such as flame retardant, a compatibilizing agent, or a stabilizing agent used as an additive is not melted. Thus, even if shear is applied to the powder material in the same manner as when shear is applied to the resin pellet, heat is rapidly generated by friction between the powder material and a cylinder inner wall surface to deteriorate the resin. Also, the powder material is more bulky than the pellet and easily causes a gap in the cylinder, and heat from the heater 24 provided around the outer periphery of the cylinder is not easily transferred. Thus, in the compression zone, only the molding material near the inner wall surface of the cylinder 14 is heated to high temperature and melted, while heat is not easily transferred to the molding material on the shaft side of the screw 16, and the molding material is not easily melted. Thus, in short-time measurement, the molding material near the shaft side of the screw 16 is not melted and fed through the measuring zone to the tip of the screw. Thus, uniform kneading of the molding material containing a large amount of powder material cannot be performed, and quality (strength, flame retardancy, color of appearance, or the like) of the molded product obtained by injection molding is reduced. In fact, when the molding material containing 30% by weight or more powder material is molded by the conventional molding method, and the screw 16 is withdrawn from the cylinder 14 and observed at that time, the molding material near the inner wall surface of the cylinder 14 is melted in a finish position of the compression zone, while the molding material near the shaft of the screw 16 remains unmelted in the powder form. This will be described in more detail with reference to FIGS. 5 and 6.

FIG. 5 illustrates melting behavior of a molding material in the compression zone when a molding material containing 100% pellet is fed into the cylinder by a conventional normal feeding method of feeding the molding material into the cylinder 14 so as to fill the cylinder 14. At an entrance of the compression zone, as shown in Portion A in FIG. 5, a solid bed layer S of an unmelted molding material is formed, and a melt film layer M of a melted molding material is formed on the inner wall surface of the cylinder 14. When the melt film layer M is formed, heat generated by shear energy melts the solid bed layer S, and as shown in Portion B in FIG. 5, a melt pool P in which the unmelted molding material is dispersed is formed in a center of the compression zone. As shown in Portion C in FIG. 5, at an exit of the compression zone, there is little unmelted molding material in the melt pool P. This allows uniform kneading.

FIG. 6 illustrates melting behavior of a molding material in the compression zone when a molding material containing 30% by weight or more powder (the balance is a pellet) is fed into the cylinder 14 by the conventional normal feeding method. At the entrance of the compression zone, as shown in Portion A in FIG. 6, the powder and the pellet are separated during conveyance of the screw 16, a pellet layer X is formed on the side of the cylinder 14, and a powder layer Y is formed on the shaft side of the screw 16. The pellet layer X close to the cylinder 14 is first melted to form a melt film layer M as shown in Portion B in FIG. 6. However, with the powder layer Y, a melt pool P is not formed over the compression zone as in the case of 100% pellet, thereby reducing heat transfer to the entire compression zone. Thus, as shown in Portion C in FIG. 6, also at the exit of the compression zone, the powder layer Y adheres around the shaft of the screw 16 and is wound around the shaft of the screw 16 and fed to the measuring zone. Thus, the molding material that is not sufficiently uniformly kneaded reaches the measuring zone, thereby reducing quality of an injected molded product.

When biomass resin, for example, polylactic acid is used as base resin, a melting point of polylactic acid is around 170° C., but decomposition rapidly starts around 220° C. The melting point temperature and the decomposition temperature are close and thus heating and melting is very difficult. Since fluidity is very low around the melting point, it is desirable to melt the molding material at as high a temperature as possible. In particular, the molding material containing polylactic base resin and 30% by weight or more powder that is not easily melted as described above can be heated and melted only when a molding set temperature is increased to around 200° C. However, for the molding material containing a large amount of powder material, the temperature is increased 15 to 25° C. higher than the molding set temperature of the cylinder 14 by shear heating, and the temperature in the cylinder is increased to around 220° C.

However, even if the molding material containing 30% by weight or more powder is directly fed into the cylinder 14, a long measuring time is ensured irrespective of the screw rotation speed and the back pressure set value to ensure the screw rotation speed required for kneading, thereby significantly reducing density of the molding material in the cylinder 14, particularly, in the compression zone. Thus, excessive shear is not applied to the molding material, thereby preventing an increase in temperature in the cylinder by shear heating. Even with low density of the molding material in the cylinder, the long measuring time is ensured and thus heat on the side of the cylinder 14 is slowly transferred to the shaft side of the screw 16, and the screw rotation speed can be increased with the long measuring time being ensured, thereby increasing kneading efficiency. Thus, even for the molding material containing 30% by weight or more powder, the melt pool P is easily formed over the compression zone, thereby allowing uniform kneading without reducing quality of the molded product.

Uniform kneading that does not reduce quality of a molded product can be achieved by setting the rotation speed of the screw 16 to a constant rotation speed of 50 to 300 rpm suitable for kneading when the back pressure is set to the predetermined value, while adjusting the feeding speed of the molding material so that a measuring time becomes twice the measuring time SN seconds (SN is the measuring time in the normal feeding method) to 180 seconds irrespective of the rotation speed of the screw 16 and the back pressure set value to ensure the measuring time.

In this case, the molding material is preferably fed so that a space before at least the compression zone among the three zones: the feeding zone, the compression zone, and the measuring zone in the cylinder 14 is not filled with the molding material. Specifically, it is preferable that at a start of injection molding, a state where the space before at least the compression zone is not filled with the molding material is formed, and in this state, the molding material is added from the volumetric feeder 40 at a feeding speed lower than that for an average consumption amount of the molding material in the normal feeding method. Thus, the state where the cylinder 14 is not filled with the molding material at the start of the injection molding can be maintained after continued injection molding.

In particular, the compression zone is not filled with the molding material, and thus heat transfer from the side of the cylinder 14 to the shaft side of the screw 16 is increased, thereby facilitating melting of the powder layer formed on the shaft side.

A required measuring time in the range of twice the measuring time SN to 180 seconds can be previously determined by a test or the like from composition of the molding material or conditions of the injection molding apparatus. The range of twice the measuring time SN to 180 seconds has no problem for the molding material containing 30% by weight or more powder, and may be applied to a molding material containing such as 100% pellet having a less-strict molding condition.

The measuring time controlled in accordance with the required kneading time can be set within a total time of the cooling step and the releasing step in view of a mixing property of the material. The measuring time is preferably matched with the total time of the cooling step and the releasing step because higher kneading performance can be obtained.

This can eliminate the waiting step described above, and thus the rotating state of the screw 16 can be always maintained in the measuring step.

When the measuring time is longer than the total time, it is preferable that a condition with an increased rotation speed of the screw 16 is selected from the required kneading time data, and the measuring time is matched with the total time.

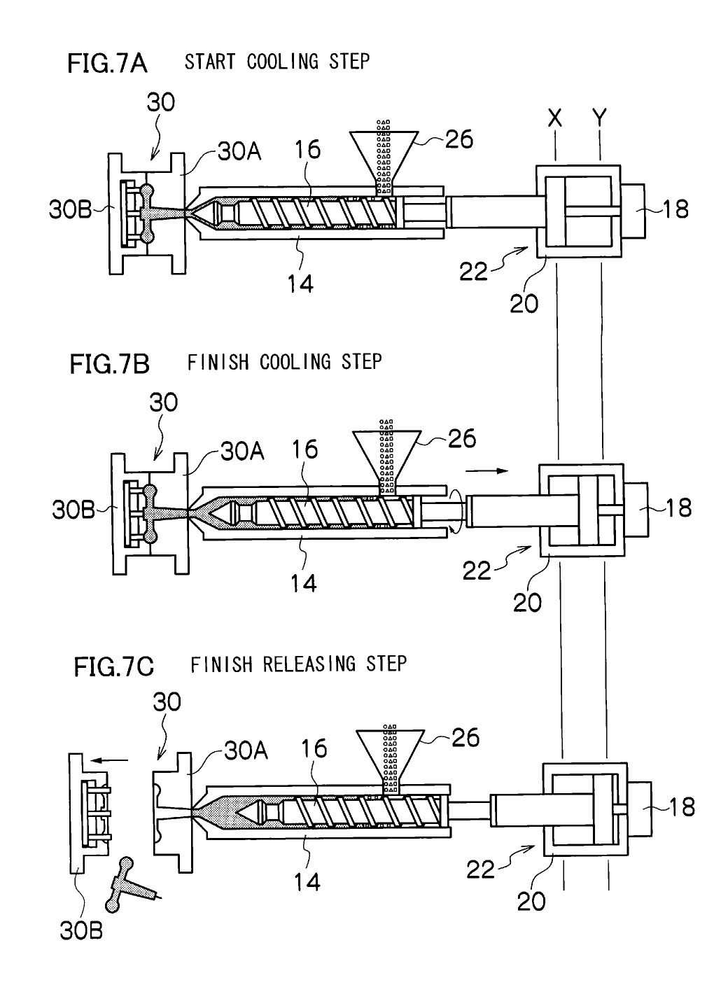

FIGS. 7A to 7C show images of the measuring step when the measuring time controlled in accordance with the required kneading time matches the total time of the cooling step and the releasing step. A feeding speed of the molding material at this time is Q grams per minute (g/min) FIG. 7A shows a start of the cooling step, FIG. 7B shows a finish of the cooling step, and FIG. 7C shows a finish of the releasing step. In advancing and retracting strokes of the screw 16, the most advanced position (left position in FIG. 7) is an X position, and the most retracted position is a Y position.

At the same time as the start of the cooling step in FIG. 7A, the molding material is fed into the cylinder 14 at the feeding speed of Q g/min to start the measuring step. The position of the screw 16 at this time is in the X position on the side closest to the nozzle in the advancing and retracting strokes of the screw 16.

As the molding material is fed, back pressure is increased, and the screw 16 is rotated and gradually retracted by the back pressure. Then, as shown in FIG. 7B, at the finish of the cooling step, the screw 16 is positioned slightly closer to the Y side than the middle between the X position and the Y position. Further, as the molding material is continuously fed, the screw is retracted, and as shown in FIG. 7C, the screw 16 reaches the Y position at the same time as the finish of the releasing step.

Thus, in the injection molding method according to the first embodiment of the presently disclosed subject matter, the measuring time can be controlled in accordance with the required kneading time. Thus, for a molding material that requires a long time for kneading, uniform and sufficient kneading can be performed. Thus, the presently disclosed subject matter is particularly effective as an injection molding method by direct mixing of biomass resin.

### Second Embodiment

A second embodiment of the presently disclosed subject matter relates to synchronous feeding in an injection molding method.

Synchronous feeding in the presently disclosed subject matter can be performed to prevent clogging and uniformly knead a molding material in a cylinder 14 even in a case where a molding material containing at least a powder material and a pellet material among the powder material, the pellet material, and a liquid material is directly fed via a hopper 26 of an injection molding apparatus 10 into the cylinder 14 for injection molding.

However, it goes without saying that the synchronous feeding is combined with the “measuring time control” described above to further provide an advantage of the synchronous feeding.

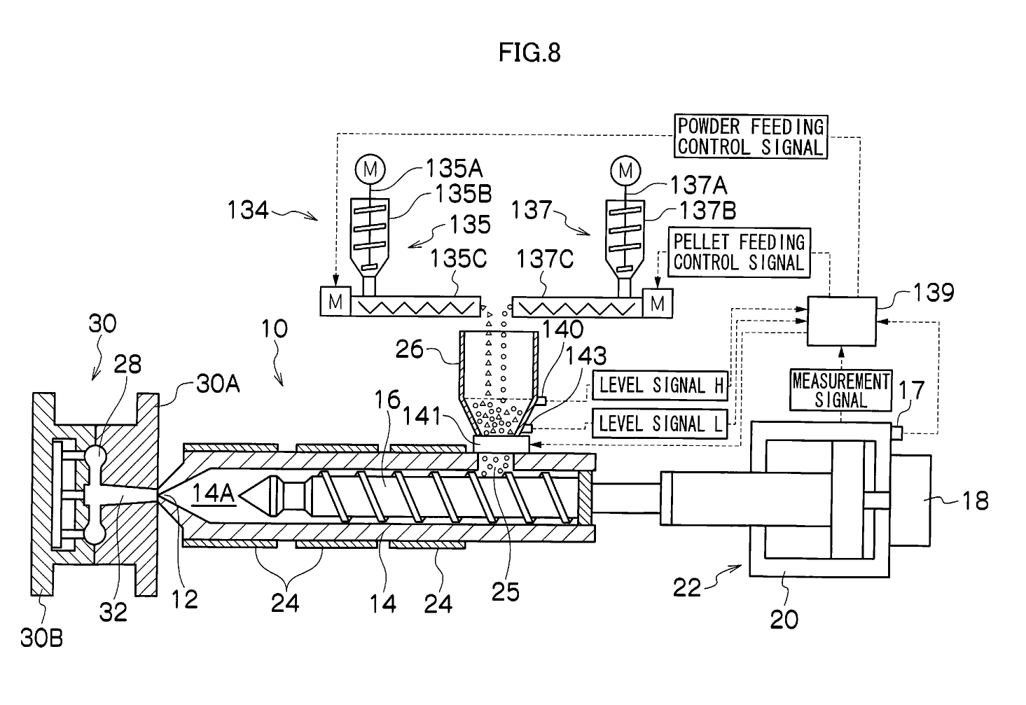

FIG. 8 is a schematic configuration diagram showing an example of an injection molding apparatus that can carry out the synchronous feeding. A basic configuration of the injection molding apparatus 10 is the same as in FIG. 1, and a material feeding device 134 is configured to perform the synchronous feeding.

Thus, descriptions on the configuration of an injection molding main body of the injection molding apparatus 10 and FIGS. 2 to 7 are overlapping and thus omitted herein.

The synchronous feeding in this embodiment will be described with an example of injection molding using two types of materials: a powder material and a pellet material, but may be applied to three types of materials: a powder material, a pellet material, and a liquid material.

The material feeding device 134 mainly includes a powder feeding device 135 that feeds a powder material to the hopper 26, and a pellet feeding device 137 that feeds a pellet material to the hopper 26.

The powder feeding device 135 includes a powder mixing tank 135B including an agitator 135A and a drying device (not shown), and a powder measuring feeder 135C that feeds a powder material to the hopper 26. In the molding material, several types of powder materials that are powder or materials corresponding to powder (for example, fiber) are previously dry blended in the powder mixing tank 135B, and then the molding material for one injection shot is fed to the hopper 26 by the powder measuring feeder 135C.

The pellet feeding device 137 includes a pellet mixing tank 137B including an agitator 137A and a drying device (not shown), and a pellet measuring feeder 137C. In the molding material, several types of pellet materials that are a pellet or materials corresponding to a pellet (granule with a large size) are previously dry blended by the pellet mixing tank 137B, and then the molding material for one injection shot is fed to the hopper 26 by the pellet measuring feeder 137C. The dry blending refers to blending while drying the material.

In FIG. 8, the powder measuring feeder 135C and the pellet measuring feeder 137C are shown as screw feeders, but a table feeder, a belt feeder, a rotary feeder, a bin discharger, a circle feeder, a vibration cutting device using a shear force, or the like may be adopted, which are appropriately used depending on a property of the molding material.

In the hopper 26, an upper limit level sensor 140 and a lower limit level sensor 143 that detect a storage amount of the molding material in the hopper 26 are provided. A level signal H from the upper limit level sensor 140 and a level signal L from the lower limit level sensor 143 are input through a signal cable or without wires to a controller 139. The controller 139 controls feeding speeds and feeding timing of the powder measuring feeder 135C and the pellet measuring feeder 137C based on the level signals H and L so that a storage amount of the molding material in the hopper 26 is between the upper limit level sensor 140 and the lower limit level sensor 143. Specifically, a time when the powder material and the pellet material for one injection shot fed from the powder measuring feeder 135C and the pellet measuring feeder 137C to the hopper 26 are stored in the hopper 26 is as short as possible. This prevents the molding material from being accumulated in the hopper 26 to separate the powder material and the pellet material.

The hopper 26 does not need to have a function of storing the material, and may have a small size that prevents the material from spilling. Thus, the hopper 26 in synchronous feeding may have a size about half of the size of the hopper 26 shown in FIG. 7.

In this embodiment, the injection molding apparatus is used to feed one injection shot of the powder material dry blended in the powder mixing tank 135B and one injection shot of the pellet material dry blended in the pellet mixing tank 137B to the hopper 26 so that feeding time periods from a start to a finish of feeding of the materials are synchronized 60% or more, and preferably 90% or more. Such a method of feeding in a synchronized manner is referred to as “synchronous feeding”.

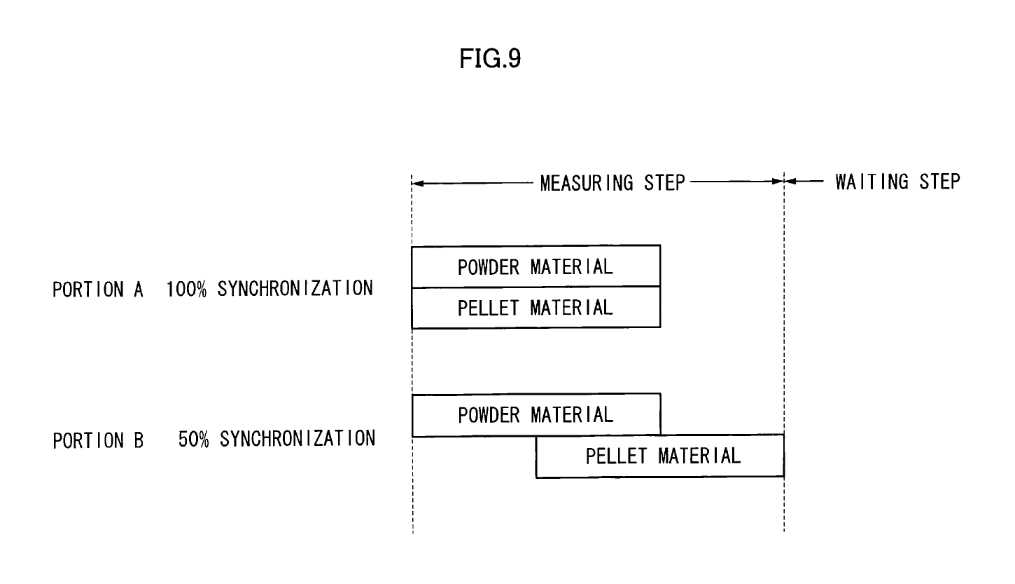

FIG. 9 shows an example of synchronous feeding of a powder material and a pellet material having different shapes, Portion A in FIG. 9 shows 100% synchronization, and Portion B in FIG. 9 shows 50% synchronization.

Thus, by 60% or more synchronization, even if materials such as the powder material and the pellet material having different shapes or specific gravities are directly fed via the hopper 26 into the cylinder 14, a blend ratio between the powder material and the pellet material can be easily made as designed.

The controller 139 finishes feeding of the molding material from the hopper 26 into the cylinder 14 within the measuring time in the measuring step of the injection molding cycle based on measurement signals that notify of the start and the finish of the measuring step from the motor/piston device 22. Thus, the powder material and the pellet material having different shapes can be smoothly taken from the inlet port 25 into the cylinder 14 during rotation of the screw, thereby preventing separation of the materials in taking.

Thus, one injection shot of each of the materials having different shapes or specific gravities is fed into the cylinder 14 using the separate measuring feeders 135C and 137C so that the feeding time periods from the start to the finish of feeding are synchronized 60% or more, and the feeding is finished within the measuring time in the measuring step of the injection molding cycle, thereby allowing a molded product having uniform quality to be stably produced.

In this embodiment, a measurement control feeder 141 of a table feeder type is provided in a lower portion of the hopper 26, and the “measuring time control” can be combined in which the feeding speed of the molding material fed from the hopper 26 into the cylinder 14 by an instruction from the controller 139 is controlled irrespective of a rotation speed of the screw 16 and a back pressure set value.

The measuring time control is described in the first embodiment and descriptions thereof will be omitted herein. In the second embodiment, required kneading time data for uniformly and sufficiently kneading the molding material is input to the controller 139 depending on various factors such as a type of the molding material (a type of resin, a type of an additive, or the like), a shape of the material (powder, granule, or pellet), a mixing ratio (a ratio between the base resin and the additive), an injection molding condition (an injection amount of one shot, a heating temperature of the cylinder, a rotation speed of the screw, a back pressure set value, or the like).

When the factors such as the type of the molding material or the molding condition are input to the controller 139, the controller 139 selects a measuring time required for the molding material from the input required kneading time data. The controller 139 also calculates a feeding speed of the molding material stored in the measurement control feeder 141 so that the measuring time from the start to the finish of the measurement is the required kneading time, and sets the speed to the measurement control feeder 141. Thus, the measurement control feeder 141 feeds the molding material stored in the hopper 26 into the cylinder 14 based on the calculated feeding speed.

Thus, the screw 16 can be rotated at high speed suitable for kneading, and also a long measuring time when the screw 16 is rotationally operated can be taken. Thus, even if, for example, a molding material containing a large amount of powder or fiber is directly fed into the cylinder 14, sufficient kneading can be performed. The long measuring time can be taken irrespective of the rotation speed of the screw 16, and thus even if the molding material containing powder is directly fed into the cylinder 14, the feeding capacity of the screw 16 is definitely higher as compared with the feeding speed of the molding material. This prevents clogging of the molding material at an outlet port of the hopper 26 or in the cylinder 14.

The synchronous feeding in the second embodiment is particularly effective when direct mixing (DM method) is performed using a molding material having a powder ratio of 30% by weight or more, more preferably 50% by weight or more. This is because the powder material having a shape and a specific gravity different from those of the pellet material is easily separated with time in the hopper 26, and the synchronous feeding is extremely effective for preventing the separation.

Next, preferred conditions of the molding material used in the first and second embodiments of the presently disclosed subject matter will be described.

The presently disclosed subject matter may be applied to petroleum resin, but is preferably applied to biomass resin such as polylactic resin or cellulose resin.

Various polylactic resin including, for example, lactic acid homopolymer resin and lactic acid copolymer resin may be used. A lactic acid component that is a raw material of polylactic resin is not particularly limited, but for example, L-lactic acid, D-lactic acid, DL-lactic acid, or mixtures thereof, or L-lactide, D-lactide, meso-lactide as lactic acid cyclic dimmer, or mixtures thereof may be used.

A production method of polylactic resin used in the presently disclosed subject matter is not particularly limited, but various kinds of resin synthesized by conventionally known methods may be used. The lactic acid homopolymer resin may be obtained by directly dehydrating and condensing, for example, L-lactic acid, D-lactic acid, DL-lactic acid, or mixtures thereof, or ring-opening polymerization of L-lactide, D-lactide, meso-lactide, or mixtures thereof. The lactic acid copolymer resin may be obtained by copolymerizing, for example, lactic acid monomer or lactide with other components that can be copolymerized with the monomer. Other components that can be copolymerized include, for example, dicarboxylic acid, polyalcohol, hydroxycarboxylic acid, or lactone having two or more ester link forming functional groups in a molecule, and various kinds of polyester, various kinds of polyether, or various kinds of polycarbonate containing the various components.

A weight-average molecular weight of the polylactic resin is not particularly limited, but is preferably 50,000 to 500,000, and more preferably 100,000 to 250,000.

The weight-average molecular weight of 50,000 or more is preferable because strength of an obtained molded product in the presently disclosed subject matter is increased. The weight-average molecular weight of 500,000 or less is preferable because the molding material used for injection molding is easily made uniform, and strength of a molded product obtained by the injection molding tends to be increased.

The cellulose resin is not particularly limited, but diacetyl cellulose (DAC), triacetyl cellulose (TAC), cellulose acetate butyrate (CAB), or cellulose acetate propionate (CAP) can be preferably used. Cellulose resin supplied from cellulose resin manufacturers is generally supplied to users in a form of uneven granules having a particle size of 1 to 30 mm.

In the presently disclosed subject matter, the content of biomass resin as base resin of the molding material fed to the injection molding apparatus is preferably 30% by weight or more, and more preferably 50% by weight or more. Such a configuration can provide high environmental performance to a molded fiber-containing injection molded product.

The flame retardant used as an additive in the presently disclosed subject matter is not particularly limited, but various kinds of known flame retardant used for flame retardation of resin (molded product) can be used. For example, the flame retardant includes bromine flame retardant, chroline flame retardant, phosphorus-containing flame retardant, silicon-containing flame retardant, nitrogen compound flame retardant, inorganic flame retardant, or the like. Among the retardant, phosphorus-containing flame retardant is preferable that prevents corrosion of devices or a mold in kneading with resin or molding, hardly affects environment in burning and discarding a molded product, and has a high flame retarding effect.

The phosphorus-containing flame retardant is not particularly limited, but known phosphorus-containing flame retardant may be used. For example, the phosphorus-containing flame retardant includes organic phosphorous compound such as phosphoric ester, condensed phosphoric ester, and polyphosphate. Specifically, the phosphoric ester includes, for example, trimethyl phosphate, triethyl phosphate, tributyl phosphate, tri(2-ethylhexyl)phosphate, tributoxyethyl phosphate, triphenyl phosphate, tricresyl phosphate, trixylenyl phosphate, tris(isopropyl phenyl)phosphate, tris(phenylphenyl)phosphate, trinaphthyl phosphate, cresyl diphenyl phosphate, xylenyl diphenyl phosphate, diphenyl (2-ethylhexyl)phosphate, di(isopropyl phenyl)phenyl phosphate, monoisodecyl phosphate, 2-acryloyloxy ethyl acid phosphate, 2-methacryloyloxy ethyl acid phosphate, diphenyl-2-acryloyloxy ethyl phosphate, diphenyl-2-methacryloyloxy ethyl phosphate, melamine phosphate, dimelamine phosphate, melamine pyro-phosphate, triphenyl phosphine oxide, tricresyl phosphine oxide, methane phosphonate diphenyl, and phenyl phosphonate diethyl.

The condensed phosphoric ester includes, for example, aromatic condensed phosphoric ester such as resorcinol polyphenyl phosphate, resorcinol poly(di-2,6-xylyl) phosphate, bisphenol A polycresyl phosphate, hydroquinone poly(2,6-xylyl)phosphate, and condensates thereof.

Further, the condensed phosphoric ester may include polyphosphate containing phosphoric acid, polyphosphoric acid, and salts of metal in IA to IVB groups of the periodic table, ammonia, aliphatic amine, and aromatic amine.

Typical salts of polyphosphate include, lithium salt, sodium salt, calcium salt, barium salt, ferrous salt, ferric salt, and aluminum salt as metal salts, methylamine salt, ethylamine salt, diethylamine salt, triethylamine salt, ethylenediamine salt, and piperazine salt as aliphatic amine salts, and pyridine salt and triazine as aromatic amine salts.

In the presently disclosed subject matter, flame retardant other than the phosphorus-containing flame retardant or the silicon-containing flame retardant may be used as required. For example, inorganic flame retardant may be used such as magnesium hydroxide, aluminum hydroxide, antimony trioxide, antimony pentoxide, sodium antimonate, hydroxyzinc stannate, zinc stannate, meta-stannic acid, tin oxide, tin oxide salt, zinc sulfate, zinc oxide, ferrous oxide, ferric oxide, stannous oxide, stannic oxide, zinc borate, ammonium borate, ammonium octamolybdate, metal salt of tungsten acid, complex oxide acid of tungsten and metalloid, ammonium sulfamate, ammonium bromide, zirconium compound, guanidine compound, fluorine compound, graphite, and expansive graphite.

The fiber used as an additive in the injection molding method of the presently disclosed subject matter is preferably formed into a pellet having a length of 3 to 10 mm by bonding or embedding. Resin used for bonding or embedding preferably includes biomass resin. Both synthetic fiber and inorganic fiber may be used. For the synthetic fiber, polyester fiber, polyarylate fiber, polyamide fiber, and polyolefin fiber can provide stable quality, and polyester fiber is more preferable for sufficiently providing the function.

It is preferable to use hot-melt synthetic fiber as fiber for reinforcing a molded product because in ignition of the molded product, the fiber contracts by melting and does not protrude on the molded product surface, which does not prevent uniform generation of a char layer.

Polyester resin refers to a generic name for high molecular compound with an ester link as a main linking chain of a main chain. Thus, polyester resin includes PET (polyethylene terephthalate), PEN (polyethylene naphthalate), PTT (polytrimethylene terephthalate), PBT (polybutylene terephthalate), PPT (poly-pentamethylene terephthalate), PHT (polyhexamethylene terephthalate), PBN (polybutylene naphthalate), PES (polyethylene succinate), PBS (polybutylene succinate), and also all high-molecular compounds obtained by polycondensation reaction of dicarboxylic acid components and diol components.

Dicarboxylic acid components are not particularly limited, but may be selected depending on the intended use. Dicarboxylic acid components include, for example, aromatic dicarboxylic acid, aliphatic dicarboxylic acid, alicyclic dicarboxylic acid, oxycarboxylic acid, and multifunctional acid. Above all, aromatic dicarboxylic acid is preferable.

The aromatic dicarboxylic acid includes, for example, terephthalic acid, isophthalic acid, diphenyldicarboxylic acid, diphenyl sulfone dicarboxylic acid, naphthalene dicarboxylic acid, diphenoxyethane dicarboxylic acid, and 5-sodium sulfoisophthalic acid.

Above all, terephthalic acid, isophthalic acid, diphenyldicarboxylic acid, and naphthalene dicarboxylic acid are preferable, and terephthalic acid, diphenyldicarboxylic acid, and naphthalene dicarboxylic acid are more preferable.

The aliphatic dicarboxylic acid includes, for example, oxalic acid, succinic acid, eicosane, adipic acid, sebacic acid, dimer acid, dodecanedioic acid, maleic acid, and fumaric acid. The alicyclic dicarboxylic acid includes, for example, cyclohexane dicarboxylic acid. Among the aliphatic dicarboxylic acid and the alicyclic dicarboxylic acid, succinic acid, adipic acid, and cyclohexane dicarboxylic acid are preferable, and succinic acid and adipic acid are more preferable.

The oxycarboxylic acid includes, for example, p-oxybenzoic acid.

Further, the multifunctional acid includes, for example, trimellitic acid and pyromellitic acid.

Diol components are not particularly limited, but may be selected depending on the intended use. Diol components include, for example, aliphatic diol, alicyclic diol, aromatic diol, diethylene glycol, polyalkylene glycol. Above all, aliphatic diol is preferable.

The aliphatic diol includes, for example, ethylene glycol, propanediol, butanediol, pentanediol, hexanediol, neopentyl glycol, and triethylene glycol. Above all, propanediol, butanediol, pentanediol, and hexanediol are particularly preferable.

The alicyclic diol includes, for example, cyclohexane dimethanol. Further, the aromatic diol includes, for example, bisphenol A and bisphenol S.

A polymerization degree of polyester fiber used in the presently disclosed subject matter is not particularly limited, but inherent viscosity of 0.50 dL/g or more is preferable, and 0.70 dL/g or more is more preferable for providing a high mechanical property. An upper limit of inherent viscosity is about 3.00 dL/g.

Polyester resin used as fiber in the presently disclosed subject matter preferably has inherent viscosity of 0.36 to 1.60 dL/g, particularly, 0.52 to 1.35 dL/g when o-chlorophenol solution is measured at 25° C. Polyester resin having such inherent viscosity is preferably used in terms of mechanical characteristics and moldability.

In the presently disclosed subject matter, such fiber preferably has tensile strength of 2 cN/dtex or more, and more preferably has 5 cN/dtex or more.

Such fiber can be used to increase strength of an obtained fiber-containing injection molded product. In particular, even if a mixture contains 30% by weight or more bioresin, a molded product of the mixture can maintain impact strength of 4 KJ/m² or more in a Charpy test according to JISK7110.

A sectional shape of fiber used in the presently disclosed subject matter is not particularly limited. As an example, fiber may have a circular section. In this case, production cost of fiber is reduced, and dispensability in resin composition is increased, which is preferable. Alternatively, fiber may have an irregular section or an irregular section composite section such as a star shape, a polygonal shape, an indefinite shape, or a shape with irregularities. In this case, in a mixture, a contact surface of the fiber with resin is increased to increase sealability, and strength of the fiber-containing injection molded product in the presently disclosed subject matter is increased, which is preferable. A diameter of fiber that does not have a circular section is represented by, for example, an equivalent circular area diameter (Heywood diameter).

In the presently disclosed subject matter, a thickness of fiber is not particularly limited, but fiber used in a resin molded product reinforced with fiber may be used. For example, an appropriate thickness may be selected depending on use of the injection molded product, an injection molding apparatus used, a size of a resin pellet, or the like.

In the presently disclosed subject matter, a material fed to the injection molding apparatus may contain a nucleating agent. The material containing the nucleating agent can improve moldability, heat resistance, and product strength. The nucleating agent used is not particularly limited, but known agents blended as nucleating agents of resin (polymer) may be used. The nucleating agent may be an inorganic nucleating agent or an organic nucleating agent.

The inorganic nucleating agent includes talc, kaolinite, montmorillonite, synthetic mica, clay, zeolite, silica, graphite, carbon black, zinc oxide, magnesium oxide, titanium oxide, calcium sulfide, boron nitride, calcium carbonate, barium sulfate, aluminum oxide, neodymium oxide, and metal salt of phenylphosphonate, and the like.

The organic nucleating agent includes organic carboxylate metal salt such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, and sodium cyclohexane carboxylate; organic sulfonate such as sodium p-toluenesulfonate and sodium sulfoisophthalate; carboxylic amide such as stearic acid amide, ethylenebislauric acid amide, palmitic acid amide, hydroxystearic acid amide, erucic acid amide, and trimesic acid tris(t-butyramide), benzylidene sorbitol and derivatives thereof; phosphorus compound metal salt such as sodium-2,2′-methylenebis(4,6-di-t-butylphenyl)phosphate and 2,2-methylbis(4,6-di-t-butylphenyl)sodium, and the like.

The inorganic nucleating agent and the organic nucleating agent may be used alone or in combination of two or more thereof.

In a case where the molding material used in the injection molding method of the presently disclosed subject matter contains the nucleating agent, the content is preferably 0.005 to 5 parts by weight, and more preferably 0.1 to 1 part by weight per 100 parts by weight of resin such as polylactic resin.

The molding material used in the injection molding method of the presently disclosed subject matter may contain a plasticizer.

A plasticizer used is not particularly limited, but various plasticizers commonly used to mold resin can be used. For example, the plasticizer includes a polyester plasticizer, a glycerol plasticizer, a polyvalent carboxylic acid ester plasticizer, a polyalkylene glycol plasticizer, an epoxy plasticizer, and the like.

The polyester plasticizer includes, for example, polyester formed of an acid component such as adipic acid, sebacic acid, terephthalic acid, isophthalic acid, naphthalenedicarboxylic acid, diphenyldicarboxylic acid, and rosin, with a diol component such as propylene glycol, 1,3-butanediol, 1,4-butanediol, 1,6-hexanediol, ethylene glycol, and diethylene glycol, and polyester formed of hydroxylcarboxylic acid such as polycaprolactone.

These polyesters may be end-capped by monofunctional carboxylic acid or monofunctional alcohol, or by epoxy compound or the like.

The glycerol plasticizer includes, for example, glycerol monoacetomonolaurate, glycerol diacetomonolaurate, glycerol monoacetomonostearate, glycerol diacetomonooleate, and glycerol monoacetomonomontanate.

The polyvalence carboxylate plasticizer includes, for example, phthalate such as dimethyl phthalate, diethyl phthalate, dibutyl phthalate, dioctyl phthalate, diheptyl phthalate, dibenzyl phthalate, and butylbenzyl phthalate, trimellitate such as tributyl trimellitate, trioctyl trimellitate, and trihexyl trimellitate, adipate such as diisodecyl adipate, n-octyl-n-decyl adipate, methyl diglycol butyl diglycol adipate, benzylmethyl diglycol adipate, and benzylbutyl diglycol adipate, citrate such as triethyl acetyl citrate and tributyl acetylcitrate, azelate such as di-2-ethylhexyl azelate, dibutyl sebacate, and di-2-ethylhexyl sebacate.

The polyalkylene glycol plasticizer, includes, for example, polyalkylene glycol such as polyethylene glycol, polypropylene glycol, poly(ethylene oxide-propylene oxide) block and/or random copolymer, polytetramethylene glycol, bisphenol-ethylene oxide addition polymer, bisphenol-propylene oxide addition polymer, and bisphenol-tetrahydrofuran addition polymer, and terminal epoxidized compound, terminal esterified compound, and terminal etherified compound of the polyalkylene glycol.

The epoxy plasticizer generally refers to epoxy triglyceride or the like formed of alkyl epoxy stearate and soybean oil. Besides, so-called epoxy resin made from mainly bisphenol A and epichlorohydrin may be used.

Other plasticizers include benzoate of aliphatic polyol such as neopentyl glycol dibenzoate, diethylene glycol dibenzoate, and triethylene glycol di-2-ethyl butyrate, fatty acid amide such as stearic acid amide, aliphatic carboxylate such as butyl oleate, oxyacid ester such as methyl acetyl ricinoleate and butyl acetyl ricinoleate, pentaerythritol, various sorbitols, or the like.

In a case where the molding material used in the injection molding method of the presently disclosed subject matter contains the plasticizer, the content is preferably 1 to 30 parts by weight, and more preferably 5 to 10 parts by weight per 100 parts by weight of resin such as polylactic resin. When the molding material contains the plasticizer of the content in the preferable range, a molding temperature can be reduced about 10° C. in production of the molded product in the presently disclosed subject matter.

The molding material used in the injection molding method of the presently disclosed subject matter may contain, other than the nucleating agent and plasticizer, components such as surface active agent, elastomer, antioxidant, thermal stabilizer, ultraviolet absorber, light stabilizer, antistatic agent, neutralizer, colorant such as pigment, dispersant, rosin, synthetic rubber, mineral additive, antimicrobial agent, fragrance, mold release agent, antihydrolytic agent, or the like, as required.

In the molding material used in the presently disclosed subject matter, a total content of components other than resin, flame retardant and fiber is preferably 20% by weight or less, and more preferably 10% by weight or less.

The injection molding method of the presently disclosed subject matter has been described above in detail. The presently disclosed subject matter is not limited to the above-described examples, but, of course, various improvements or changes may be made without departing from the gist of the presently disclosed subject matter.

### EXAMPLE

### [Test A]

Next, a specific example of the injection molding method of the first embodiment of the presently disclosed subject matter will be described by Test A.

### [Molding Material]

| | | |
|---|---|---|
| polylactic resin (pellet) . . . LACEA H100 | 100 | parts by weight |
| produced by Mitsui Chemicals, Inc. | | |
| compatibilizing agent (powder) . . . Rabitle FP110 | 20 | parts by weight |
| produced by FUSHIMI Pharmaceutical Co., Ltd. | | |
| stabilizing agent (powder) . . . CARBODILITE LA1 | 5 | parts by weight |
| produced by Nisshinbo Chemical Inc. | | |
| flame retardant (powder) . . . ADK STAB FP2100 | 35 | parts by weight |
| produced by ADEKA CORPORATION | | |
| glass fiber . . . FT592 produced by Owens Corning | 15 | parts by weight |
| | | (fiber compressed |
| | | into a pellet) |
| <Total> | 175 | parts by weight |

The polylactic resin previously dried by a hot air dryer at 80° C. for 5 hours was used. The flame retardant previously reduced in pressure and dried by a pressure reducing dryer at 80° C. for 5 hours was used. A powder ratio of the molding material was 34% by weight.

### [Injection Molding Apparatus]

As an injection molding apparatus, α50-A produced by FANUC

CORPORATION was used in the test, and a mold that can simultaneously perform injection molding of a Charpy test piece and a UL test piece (thickness of 1.6 mm) was set in the injection molding apparatus. Heater temperatures of the injection molding apparatus were set to 195° C., 195° C., 190° C., 180° C., and 30° C. from a nozzle side. An injection amount of one shot was set to 25 g. Although the injection molding apparatus 10 includes three heaters 24 in FIG. 8, the injection molding apparatus employed in this test A.

For test pieces molded under injection molding conditions in Examples 1 to 6 and Comparative examples 1 to 7 described later, three items: “Charpy impact”, “flammability” and “dispensability” were evaluated. Test methods for the evaluations are as described below.

### (Charpy Impact Test)

A Charpy impact test piece was formed to have a length of 80 mm±2 mm, a width of 10 mm±0.2 mm, and a thickness of 4 mm±0.2 mm according to JISK-7111, and notching (a radius of a notch of 0.25 mm±0.05 mm, a width of a notch portion of 8.0 mm±0.2 mm) was performed. A mass of the test piece with a notch was 4.2 g. As a test device, IMPACT TESTER (analogue type) produced by TOYO SEIKI SEISAKU-SHO, LTD. was used. The test pieces obtained by the examples and the comparative examples were subjected to a Charpy impact test according to JISK-7111, and 5 (KJ/m²) or more was acceptable.

### (Flammability Test: UL94-V)

As a test piece, an injection molding test piece having a length of 127 mm, a width of 12.7 mm, and a thickness of 1.6 mm was used. UL94-V is the most basic flammability test of plastic components or the like, and applies a flame of a gas burner to a test piece having a specified size to check flammability of the test piece. Levels of flame retardancy were 5VA, 5VB, V-0, V-1, V-2, and HB in descending order, and flame retardancy V-1 or more (5VA to V-1) was acceptable.

### (Dispersibility Test)

As a test piece, an injection molding test piece having a length of 127 mm, a width of 12.7 mm, a thickness of 1.6 mm was used according to UL94. The test piece was placed on a light table (white light) having illuminance of 3800 Lx to 4200 Lx, and dispensability was visually observed by a transmitted light transmitted through the test piece. Then, the following five-grade evaluation of A to E was performed.

A . . . no aggregate is found in the test piece, and color is uniform.

B . . . no aggregate is found in the test piece, but unevenness in color is observed.

C . . . a minute aggregate having a length of 0.5 mm or more is observed in the test piece.

D . . . five or more aggregates each having a length of 0.5 mm or more are observed in the test piece.

E . . . ten or more aggregates each having a length of 1 mm or more are observed in the test piece.

### (Determination)

When all the three evaluation items were acceptable, it was evaluated to be acceptable in determination, and even one of the evaluation items was unacceptable, it was evaluated to be unacceptable in determination.

### [Injection Molding Conditions and Results of Examples and Comparative Examples in Test A]

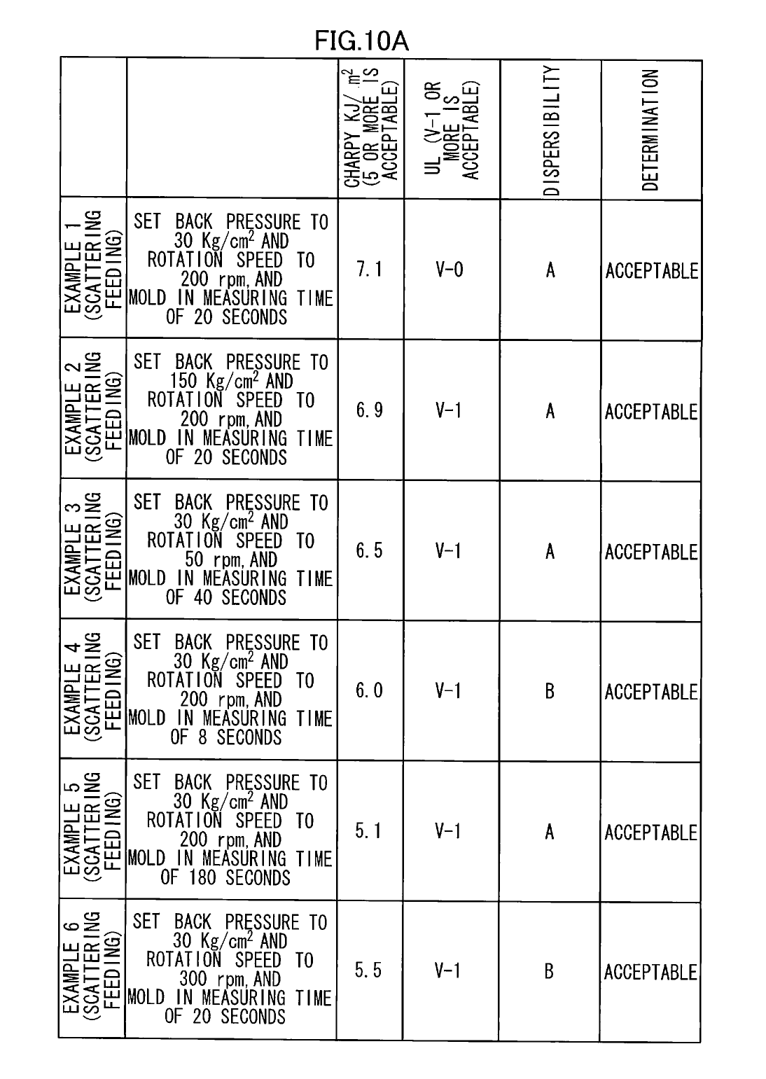

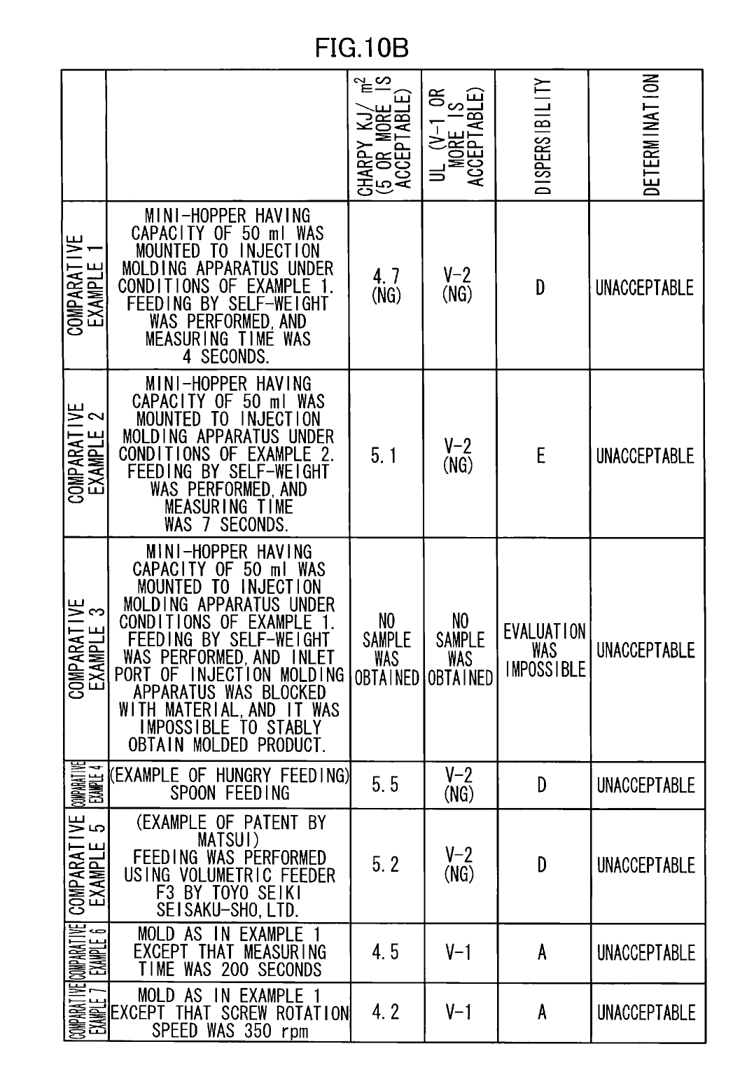

FIG. 10A shows injection molding conditions and results of examples, and FIG. 10B shows injection molding conditions and results of comparative examples.

### Example 1

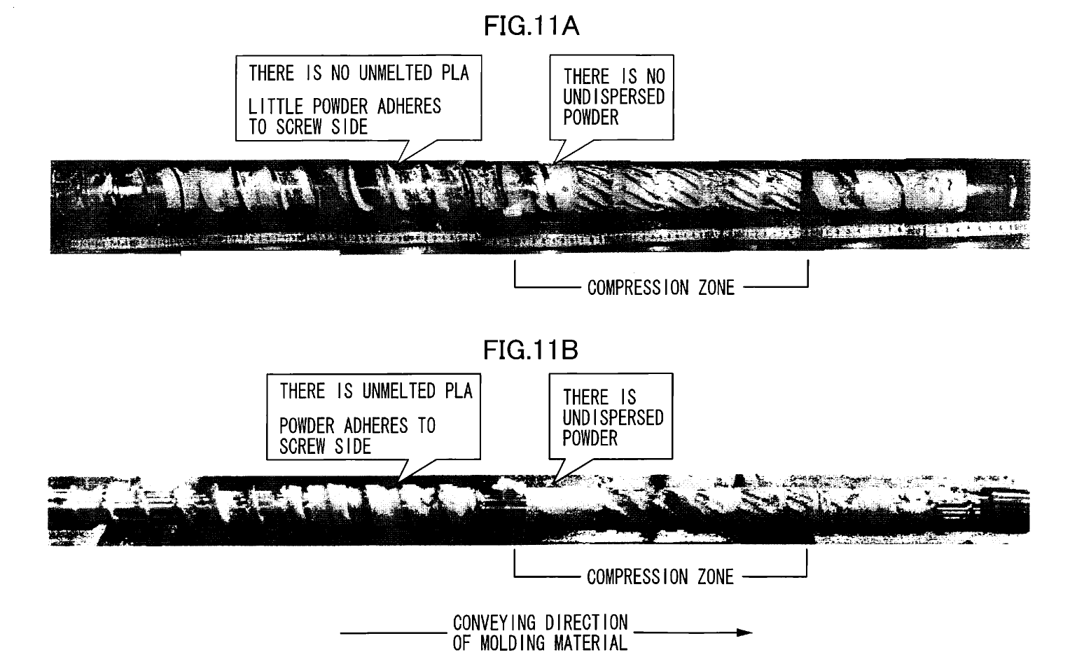

In Example 1, a small measuring feeder was mounted to the injection molding apparatus, the molding material having the above composition was placed into a plastic bag, sufficiently shaken and uniformly mixed, and then placed into the measuring feeder. Back pressure was set to 30 kg/cm², and a rotation speed of the screw was set to 200 rpm, and the molding material was fed into the cylinder at a feeding speed at which a measuring time was 20 seconds. Specifically, in Example 1, the feeding speed of the molding material fed into the cylinder was adjusted irrespective of the rotation speed of the screw and a back pressure set value, and thus the measuring time in a measuring step was controlled to 20 seconds. As a result, uniform kneading of a pellet material and a powder material was sufficiently performed, and a Charpy impact test result was 7.1 (KJ/m²), flame retardancy was V-0, dispensability was A, and it was determined to be acceptable. FIG. 11A is a photograph showing a screw shaft of the injection molding apparatus in Example 1, and white portions are the powder material adhering to the shaft. As is apparent from FIG. 11A, little powder material adheres to the shaft in a compression zone, and uniform kneading of the molding material is sufficiently performed.

In Comparative example 1 described later, a measuring time was SN in normal feeding with a back pressure set value of 30 kg/cm² and a screw rotation speed of 200 rpm, and the measuring time SN was 4 seconds.

### Example 2

In Example 2, injection molding was performed as in Example 1 except that back pressure was increased to 150 kg/cm². Specifically, in Example 2, an influence on the presently disclosed subject matter was checked when the same screw rotation speed and measuring time as in Example 1 were set and the back pressure was larger than Example 1. As a result, a Charpy impact test result was 6.9 (KJ/m²), flame retardancy was V-1, dispensability was A, and it was determined to be acceptable. It was found that even if the back pressure set value was increased from 30 kg/cm² to 150 kg/cm², there was little influence on quality of a molded product as long as the screw rotation speed and the measuring time were set to the conditions of the presently disclosed subject matter. Thus, the back pressure can be set to a predetermined value. In Comparative example 2 described later, a measuring time was SN in normal feeding with a back pressure set value of 150 kg/cm² and a screw rotation speed of 200 rpm, and the measuring time SN was 7 seconds.

### Example 3

Back pressure was set to 30 kg/cm², a rotation speed of the screw was set to 50 rpm, and the molding material was fed into the cylinder at a feeding speed at which a measuring time was 40 seconds. Other conditions were the same as in Example 1. Specifically, in Example 3, a reduction in kneading performance due to a reduced screw rotation speed is compensated by increasing the measuring time to 40 seconds. As a result, a Charpy impact test result was 6.5 (KJ/m²), a flame retardancy was V-1, dispensability was A, and it was determined to be acceptable.

### Example 4

Back pressure was set to 30 kg/cm², a rotation speed of the screw was set to 200 rpm, and the molding material was fed into the cylinder at a feeding speed at which a measuring time was 8 seconds. Other conditions are the same as in Example 1. Specifically, in Example 4, the same back pressure set value and screw rotation speed as in Example 1 were set, and the measuring time was set to a lower limit of the presently disclosed subject matter. As a result, a Charpy impact test result was 6.0 (KJ/m²), flame retardancy was V-1, dispensability was B, and it was determined to be acceptable.

### Example 5

Back pressure was set to 30 kg/cm², a rotation speed of the screw was set to 200 rpm, and the molding material was fed into the cylinder at a feeding speed at which a measuring time was 180 seconds. Other conditions are the same as in Example 1. Specifically, in Example 5, the same back pressure set value and screw rotation speed as in Example 1 were set, and the measuring time was set to an upper limit of the presently disclosed subject matter. As a result, a Charpy impact test result was 5.1 (KJ/m²), flame retardancy was V-1, dispensability was A, and it was determined to be acceptable. However, because of the long measuring time, the Charpy impact test result was close to an acceptable line. This may be because the long measuring time caused depolymerization by decomposition of polylactic resin.

### Example 6

Back pressure was set to 30 kg/cm², a rotation speed of the screw was set to 300 rpm, and the molding material was fed into the cylinder at a feeding speed at which a measuring time was 20 seconds. Other conditions are the same as in Example 1. Specifically, in Example 6, the same back pressure set value and measuring time as in Example 1 were set, and the screw rotation speed was set to an upper limit of the presently disclosed subject matter. As a result, a Charpy impact test result was 5.5 (KJ/m²), flame retardancy was V-1, dispensability was B, and it was determined to be acceptable. However, because of the high screw rotation speed, the Charpy impact test result was close to an acceptable line. This may be because the high screw rotation speed caused excessive shear heating to cause depolymerization by decomposition of polylactic resin.

### Comparative Example 1

Back pressure was set to 30 kg/cm², a rotation speed of the screw was set to 200 rpm, and a normal feeding method was performed in which the molding material having the above composition was placed into a mini-hopper having a capacity of 50 ml without using a measuring feeder, and fed into the cylinder so as to fill the cylinder by self-weight of the molding material. A measuring time at this time was measured and was 4 seconds. Specifically, in Comparative example 1, the molding material was fed into the cylinder in accordance with the rotation speed of the screw, that is, a material feeding capacity of the molding material, and thus the measuring time was 4 seconds. As a result, since the measuring time was too short and uniform kneading of a pellet material and a powder material was insufficiently performed, a Charpy impact test result was 4.7 (KJ/m²), flame retardancy was V-2, dispensability was D, and it was determined to be unacceptable.

FIG. 11B is a photograph showing a screw shaft of the injection molding apparatus in Comparative example 1, and white portions are the powder material adhering to the shaft. As is apparent from FIG. 11B, much powder material adheres to the shaft in a compression zone, and uniform kneading of the molding material is insufficiently performed.

### Comparative Example 2

Back pressure was set to 150 kg/cm², a rotation speed of the screw was set to 200 rpm, and a normal feeding method was performed in which the molding material having the above composition was placed into a mini-hopper having a capacity of 50 ml without using a measuring feeder, and fed into the cylinder so as to fill the cylinder by self-weight of the molding material. A measuring time at this time was measured and was 7 seconds. Specifically, in Comparative example 2, the molding material was fed into the cylinder in accordance with the rotation speed of the screw, that is, a material feeding capacity of the molding material, and thus the measuring time was 7 seconds. In this case, since the back pressure was increased from 30 kg/cm² in Comparative example 1 to 150 kg/cm², the measuring time in the normal feeding method was increased from 4 seconds in Comparative example 1 to 7 seconds. As a result, a Charpy impact test result was 5.1 (KJ/m²), flame retardancy was V-2, dispensability was E, and it was determined to be unacceptable.

### Comparative Example 3

Back pressure was set to 30 kg/cm², a rotation speed of the screw was set to 200 rpm as in Example 1, and the molding material having the above composition was placed into a mini-hopper having a capacity of 50 ml without using a measuring feeder, and fed into the cylinder by self-weight of the molding material. As a result, the inlet port of the cylinder was blocked and clogged with the molding material, and it was impossible to obtain a stable sample of a molded product, and the test was aborted. Thus, when the molding material contains a large amount of powder, clogging may be caused by some factor.

### Comparative Example 4

In Comparative example 4, a test was performed according to hungry feeding in Japanese Patent Application Laid-Open No. 2005-319813. Specifically, back pressure was set to 30 kg/cm², a rotation speed of the screw was set to 200 rpm, and the molding material was fed so that one fourth to three fourth of the screw was hidden while the inlet port of the cylinder being checked. A measuring time at this time was measured, and was the same as the measuring time of 4 seconds in the normal feeding method in Comparative example 1. As a result, since the measuring time was too short and uniform kneading of a pellet material and a powder material was insufficiently performed, a Charpy impact test result was 5.5 (KJ/m²) and acceptable, but flame retardancy was V-2 and dispensability was D, which were unacceptable, and it was determined to be unacceptable.

### Comparative Example 5

In Comparative example 5, a test was performed according to Japanese Patent Application Laid-Open No. 2001-277296. Specifically, back pressure was set to 30 kg/cm², a rotation speed of the screw was set to 200 rpm, a volumetric feeder F3 by TOYO SEIKI SEISAKU-SHO, LTD. was manually operated on/off, and the molding material was fed into the cylinder by a feeding method in Japanese Patent Application Laid-Open No. 2001-277296. A measuring time at this time was measured and was 5 seconds. As a result, since the measuring time was too short and uniform kneading of a pellet material and a powder material was insufficiently performed although, a Charpy impact test result was 5.2 (KJ/m²) and acceptable, flame retardancy was V-2 and dispensability was D, and it was determined to be unacceptable.

### Comparative Example 6

In Comparative example 6, injection molding was performed as in Example 1 except that the molding material was fed into the cylinder at a feeding speed at which a measuring time was 200 seconds. Specifically, in Comparative example 6, a back pressure set value and a screw rotation speed satisfied the presently disclosed subject matter, while the measuring time was longer than the upper limit of the presently disclosed subject matter. As a result, flame retardancy was V-1, dispensability was A, and it was determined to be acceptable. However, because of the too long measuring time, a Charpy impact test result was 4.5 (KJ/m²) that was lower than an acceptable line. This may be because the too long measuring time caused excessive depolymerization by decomposition of polylactic resin.

### Comparative Example 7

In Comparative example 7, injection molding was performed as in Example 1 except that a rotation speed of the screw was set to 350 rpm. Specifically, in Comparative example 7, a back pressure set value and a measuring time satisfied the presently disclosed subject matter, but the screw rotation speed is higher than the upper limit of the presently disclosed subject matter. As a result, flame retardancy was V-1, dispensability was A, and it was determined to be acceptable. However, because of the high screw rotation speed, a Charpy impact test result was 4.2 (KJ/m²) that was lower than an acceptable line. This may be because the too high screw rotation speed caused excessive shear heating to cause depolymerization by decomposition of polylactic resin.

### [Result and Consideration of Test A]

As is apparent from the comparison between Example 1 and Comparative example 1 and the comparison between Example 2 and Comparative example 2 described above, the injection molding method of the presently disclosed subject matter is performed of adjusting the feeding speed of the molding material so that the measuring time is controlled irrespective of the screw rotation speed and the back pressure set value, and thus good results can be obtained in all of the Charpy impact test, flame retardancy, and dispensability.

Also, for Comparative examples 4 and 5 seemingly close to the injection molding method of the presently disclosed subject matter, the Charpy impact test was improved as compared with Comparative examples 1 to 3, but flame retardancy and dispensability were lower than those in Examples 1 to 3, and satisfactory results could not be obtained.

Also, it was found that if the rotation speed of the screw exceeded 300 rpm or the measuring time exceeded 180 seconds, uniform kneading could be achieved, but depolymerization of polylactic resin occurred to affect the Charpy impact test result. Thus, it is necessary to set the rotation speed of the screw to a constant rotation speed within a range of 50 rpm (a lowest rotation speed at which sufficient kneading can be performed) to 300 rpm, and to control the feeding speed of the molding material into the cylinder can be adjusted so that the measuring time becomes twice the measuring time SN seconds in normal feeding or more and 180 seconds or less.

In this example, polylactic resin (PLA) having low heat resistance was used as base resin, but the presently disclosed subject matter may be, of course, applied to base resin having higher heat resistance than polylactic resin.

### [Test B]

Test B was performed using a molding material and an injection molding apparatus different from those in Test A.

### [Molding Material]

| | | |
|---|---|---|
| polylactic resin (granule) . . . 4032D | 100 | parts by |
| produced by NatureWorks LLC | | weight |
| flame retardant (powder) . . . ADK STAB | 40 | parts by |
| FP2200 produced by ADEKA CORPORATION | | weight |
| compatibilizing agent (powder) . . . Rabitle FP110 | 20 | parts by |
| produced by FUSHIMI Pharmaceutical Co., Ltd. | | weight |
| stabilizing agent (powder) . . . METABLEN W600A | 5 | parts by |
| produced by MITSUBISHI RAYON CO., LTD. | | weight |
| PTFE anti-drip agent (powder) . . . FA500H produced | 0.5 | parts by |
| by DAIKIN INDUSTRIES, LTD. | | weight |
| antihydrolytic agent (powder) . . . Stabaxol 1FL | 3 | parts by |
| produced by Rhein Chemie Rheinau GmbH | | weight |
| filler (fine powder) . . . P3 produced by Nippon | 8 | parts by |
| Talc Co., Ltd. | | weight |
| <Total> | 176.5 | parts by |
| | | weight |

The polylactic resin previously dried by a hot air dryer at 80° C. for 5 hours was used. The flame retardant previously reduced in pressure and dried by a pressure reducing dryer at 80° C. for 5 hours was used. A powder ratio of the molding material was 43% by weight.

### [Injection Molding Apparatus]

As an injection molding apparatus, SG150U-3 produced by Sumitomo Heavy Industries, Ltd. was used in the test, and a mold that can simultaneously perform injection molding of a Charpy test piece and a UL test piece (thickness of 1.6 mm) was set in the injection molding apparatus. Heater temperatures of the injection molding apparatus were set to 195° C., 195° C., 190° C., 180° C., and 30° C. from a nozzle side. An injection amount of one shot was set to 120 g. Although the injection molding apparatus 10 includes three heaters 24 in FIG. 8, the injection molding apparatus employed in this Test B.

As in Test A, the test was performed for a case where the presently disclosed subject matter was satisfied and a case where the presently disclosed subject matter was not satisfied, and three items: a Charpy impact test, a flame retardancy test, and a dispensability test were evaluated. Test methods and evaluation references for the three items are the same as in Test A.

### [Injection Molding Conditions and Results of Examples and Comparative Examples in Test B]

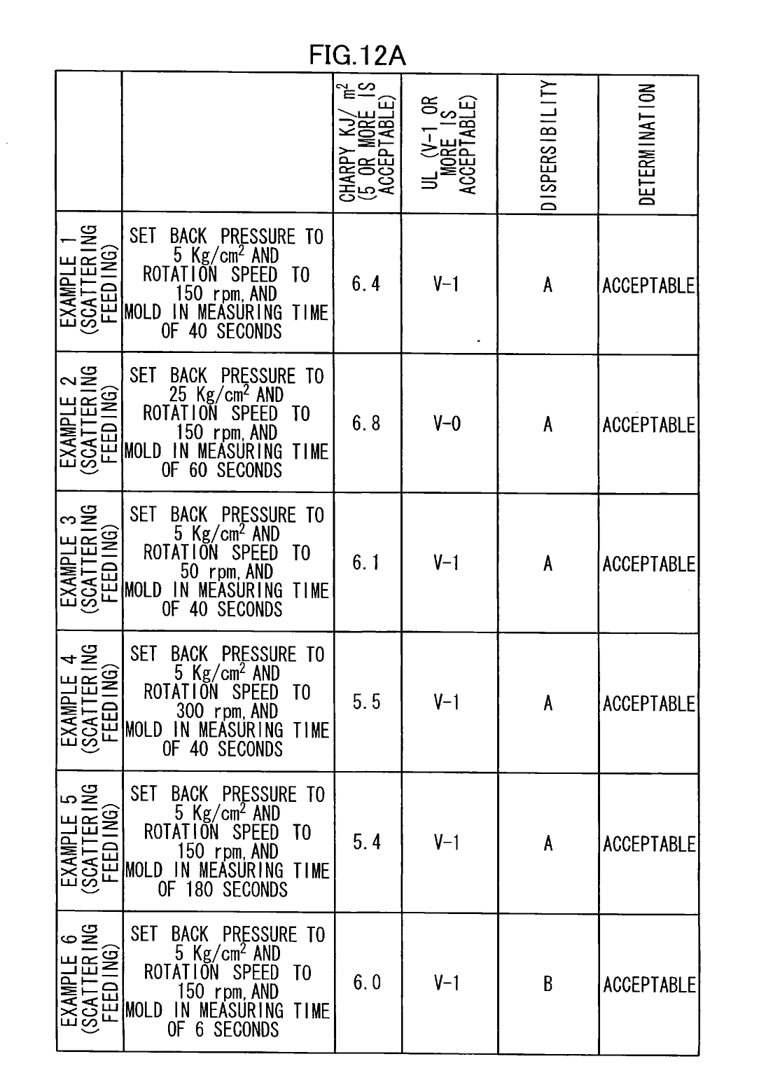

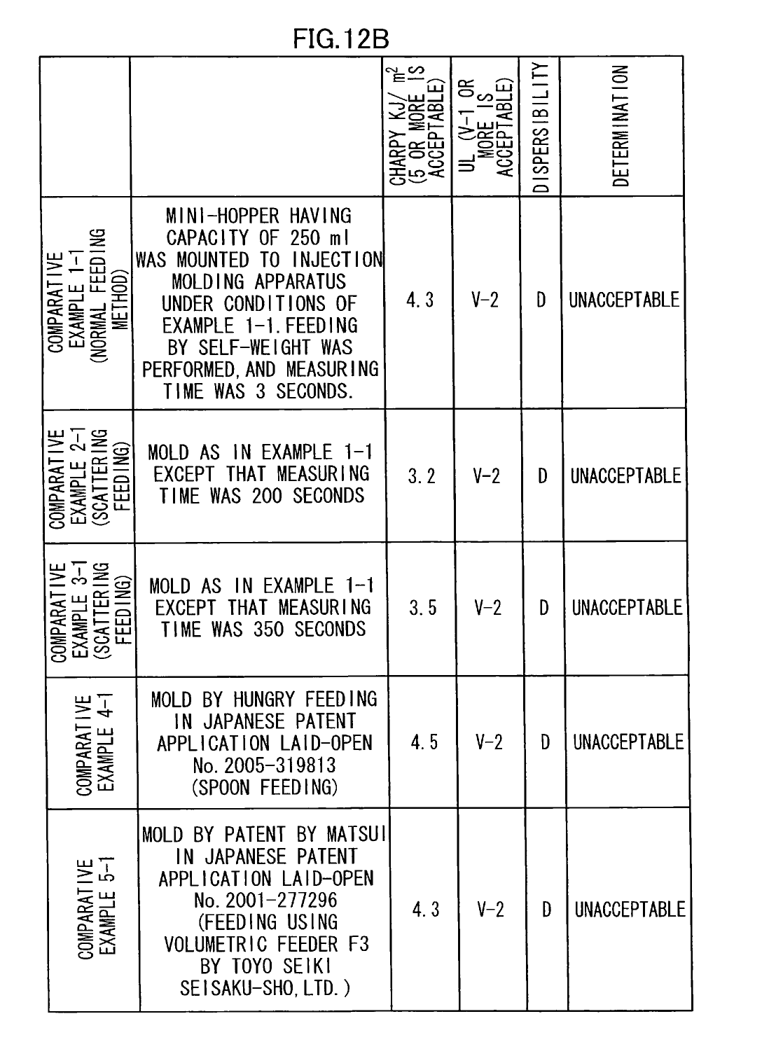

FIG. 12A shows injection molding conditions and results of examples, and FIG. 12B shows injection molding conditions and results of comparative examples.

### Example 1-1

In Example 1-1, a small measuring feeder was mounted to the injection molding apparatus, the molding material having the above composition was placed into a plastic bag, sufficiently shaken and uniformly mixed, and then placed into the measuring feeder. Back pressure was set to 5 kg/cm², and a rotation speed of the screw was set to 150 rpm, and the molding material was fed into the cylinder at a feeding speed at which a measuring time was 40 seconds. Specifically, in Example 1-1, the feeding speed of the molding material fed into the cylinder was adjusted irrespective of the rotation speed of the screw and a back pressure set value, and thus the measuring time in a measuring step was controlled to 40 seconds. As a result, uniform kneading of a pellet material and a powder material was sufficiently performed, and a Charpy impact test result was 6.4 (KJ/m²), flame retardancy was V-1, dispensability was A, and it was determined to be acceptable.

In Comparative example 1 described later, a measuring time was SN in normal feeding with a back pressure set value of 5 kg/cm² and a screw rotation speed of 150 rpm, and the measuring time SN was 3 seconds.

### Example 2-1

In Example 2-1, a small measuring feeder was mounted to the injection molding apparatus, the molding material having the above composition was placed into a plastic bag, sufficiently shaken and uniformly mixed, and then placed into the measuring feeder. Back pressure was set to 25 kg/cm², and a rotation speed of the screw was set to 150 rpm, and the molding material was fed into the cylinder at a feeding speed so that a measuring time became 60 seconds. Specifically, in Example 2-1, the feeding speed of the molding material fed into the cylinder was adjusted irrespective of the rotation speed of the screw and a back pressure set value, and thus the measuring time in a measuring step was controlled to 60 seconds. As a result, uniform kneading of a pellet material and a powder material was sufficiently performed, and a Charpy impact test result was 6.8 (KJ/m²), flame retardancy was V-0, dispensability was A, and it was determined to be acceptable.

### Example 3-1

In Example 3-1, injection molding was performed as in Example 1-1 except that a screw rotation speed was set to 50 rpm as the lower limit of the presently disclosed subject matter. As a result, a Charpy impact test result was 6.1 (KJ/m²), flame retardancy was V-1, dispensability was A, and it was determined to be acceptable. Thus, it was found that uniform kneading of a pellet material and a powder material was sufficiently performed although the screw rotation speed was set to 50 rpm as the lower limit of the presently disclosed subject matter.

### Example 4-1

In Example 4-1, injection molding was performed as in Example 1-1 except that a screw rotation speed was set to 300 rpm as the upper limit of the presently disclosed subject matter. As a result, a Charpy impact test result was 5.5 (KJ/m²), flame retardancy was V-1, dispensability was A, and it was determined to be acceptable. This may be because the screw rotation speed was set to 300 rpm as the upper limit of the presently disclosed subject matter, and thus shear heating occurred to cause depolymerization by decomposition of polylactic resin, thereby somewhat affecting the Charpy impact test result.

### Example 5-1

In Example 5-1, injection molding was performed as in Example 1-1 except that a measuring time was set to 180 seconds as the upper limit of the presently disclosed subject matter. As a result, a Charpy impact test result was 5.4 (KJ/m²), flame retardancy was V-1, dispensability was A, and it was determined to be acceptable. This may be because the measuring time was increased to 180 seconds as the upper limit of the presently disclosed subject matter, and thus depolymerization was caused by decomposition of polylactic resin, thereby somewhat affecting the Charpy impact test result.

### Example 6-1

In Example 6-1, injection molding was performed as in Example 1-1 except that a measuring time was set to 6 seconds which is twice a measuring time SN in normal feeding as the lower limit of the presently disclosed subject matter. A measuring time in Comparative example 1-1 was the measuring time in normal feeding and was 3 seconds. As a result, a Charpy impact test result was 6.0 (KJ/m²), flame retardancy was V-1, dispensability was B, it was determined to be acceptable. Although the measuring time was 6 seconds as the lower limit of the presently disclosed subject matter and short, uniform kneading could be achieved such that all of the Charpy impact test, the flame retardancy, and the dispensability were acceptable.

### Comparative Example 1-1

Back pressure was set to 5 kg/cm², a rotation speed of the screw was set to 150 rpm, and a normal feeding method was performed in which the molding material having the above composition was placed into a mini-hopper having a capacity of 250 ml without using a measuring feeder, and fed into the cylinder so as to fill the cylinder by self-weight of the molding material. A measuring time at this time was measured and was 3 seconds. Specifically, in Comparative example 1-1, the molding material was fed into the cylinder in accordance with the rotation speed of the screw, that is, a material feeding capacity of the molding material, and thus the measuring time was 3 seconds. As a result, since the measuring time was too short and uniform kneading of a pellet material and a powder material was insufficiently performed, a Charpy impact test result was 4.3 (KJ/m²), flame retardancy was V-2, dispensability was D, and it was determined to be unacceptable.

### Comparative Example 2-1

In Comparative example 2-1, injection molding was performed as in Example 1-1 except that a measuring time was 200 seconds. Specifically, in Comparative example 2-1, the measuring time was longer than the upper limit of the presently disclosed subject matter. As a result, dispensability was A and acceptable, but a Charpy impact test result was 3.2 (KJ/m²) and flame retardancy was V-2, and it was determined to be unacceptable. This may be because the measuring time was 200 seconds and too long, and excessive depolymerization was caused by decomposition of polylactic resin, and the Charpy impact test result was unacceptable.

### Comparative Example 3-1

In Comparative example 3-1, injection molding was performed as in Example 1-1 except that a screw rotation speed was 350 rpm. Specifically, in Comparative example 3-1, the screw rotation speed was higher than the upper limit of the presently disclosed subject matter. As a result, dispensability was A and acceptable, but a Charpy impact test result was 3.5 (KJ/m²) and flame retardancy was V-2, and it was determined to be unacceptable. This may be because the too high screw rotation speed caused excessive depolymerization by decomposition of polylactic resin, and the Charpy impact test result was unacceptable.

### Comparative Example 4-1

In Comparative example 4-1, a test was performed according to hungry feeding in Japanese Patent Application Laid-Open No. 2005-319813. Specifically, back pressure was set to 5 kg/cm², a rotation speed of the screw was set to 150 rpm, and the molding material was fed so that one fourth to three fourth of the screw was hidden while the inlet port of the cylinder being checked. A measuring time at this time was measured and was the same as the measuring time of 3 seconds in the normal feeding method in Comparative example 1-1. As a result, since the measuring time was too short and uniform kneading of a pellet material and a powder material was insufficiently performed, a Charpy impact test result was 4.5 (KJ/m²), flame retardancy was V-2, dispensability was D, and it was determined to be unacceptable.

### Comparative Example 5-1

In Comparative example 5-1, a test was performed according to Japanese Patent Application Laid-Open No. 2001-277296. Specifically, back pressure was set to 5 kg/cm², a rotation speed of the screw was set to 150 rpm, a volumetric feeder by TOYO SEIKI SEISAKU-SHO, LTD. was manually operated on/off, and the molding material was fed into the cylinder by a feeding method in Japanese Patent Application Laid-Open No. 2001-277296. A measuring time at this time was measured and was 4 seconds. As a result, since the measuring time was too short and uniform kneading of a pellet material and a powder material was insufficiently performed, a Charpy impact test result was 4.3 (KJ/m²), flame retardancy was V-2, dispensability was D, and it was determined to be unacceptable.

### [Consideration of Test Results]

The results of Test B were similar to the results of Test A, and it was found that differences in the molding material and the injection molding apparatus do not affect the presently disclosed subject matter.

The results of Tests A and B proved that, as in the injection molding method of the presently disclosed subject matter, high speed rotation is performed at the rotation speed of the screw of 50 to 300 rpm, the measuring time is controlled irrespective of the rotation speed of the screw and the back pressure set value, and set to the measuring time of twice SN (measuring time in normal feeding) to 180 second, and thus uniform kneading can be performed even if the molding material containing a large amount of powder is directly fed from the hopper into the cylinder.

The measuring time of hungry feeding performed as the comparative example was similar to the measuring time in normal feeding, and was shorter than the measuring time in “scattering feeding” in the presently disclosed subject matter.

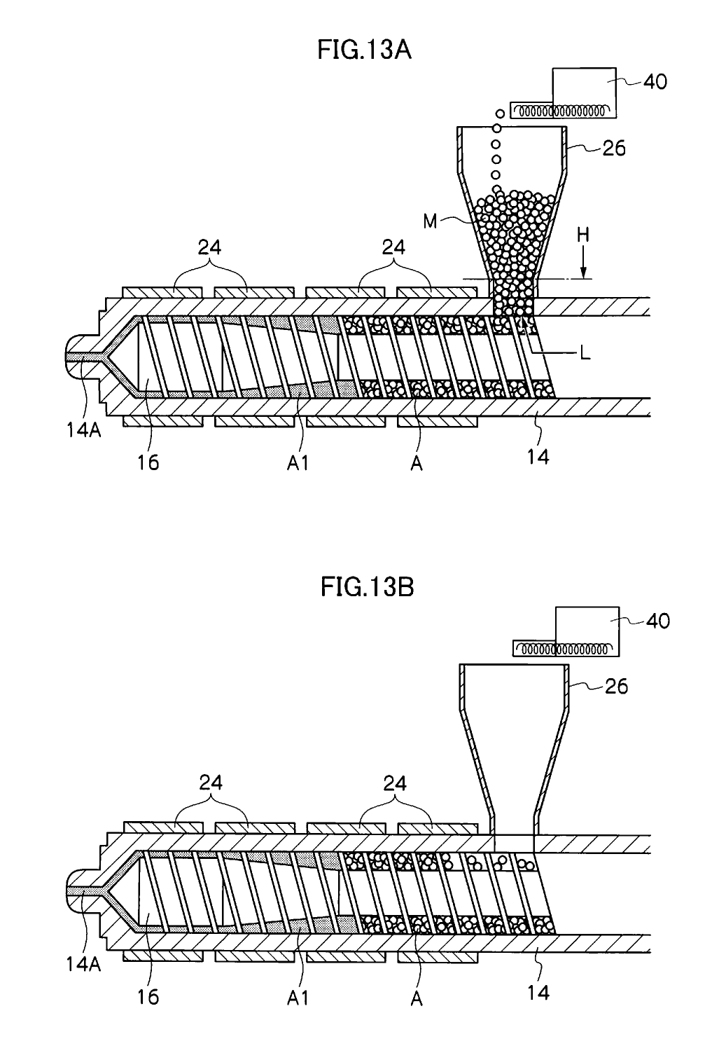

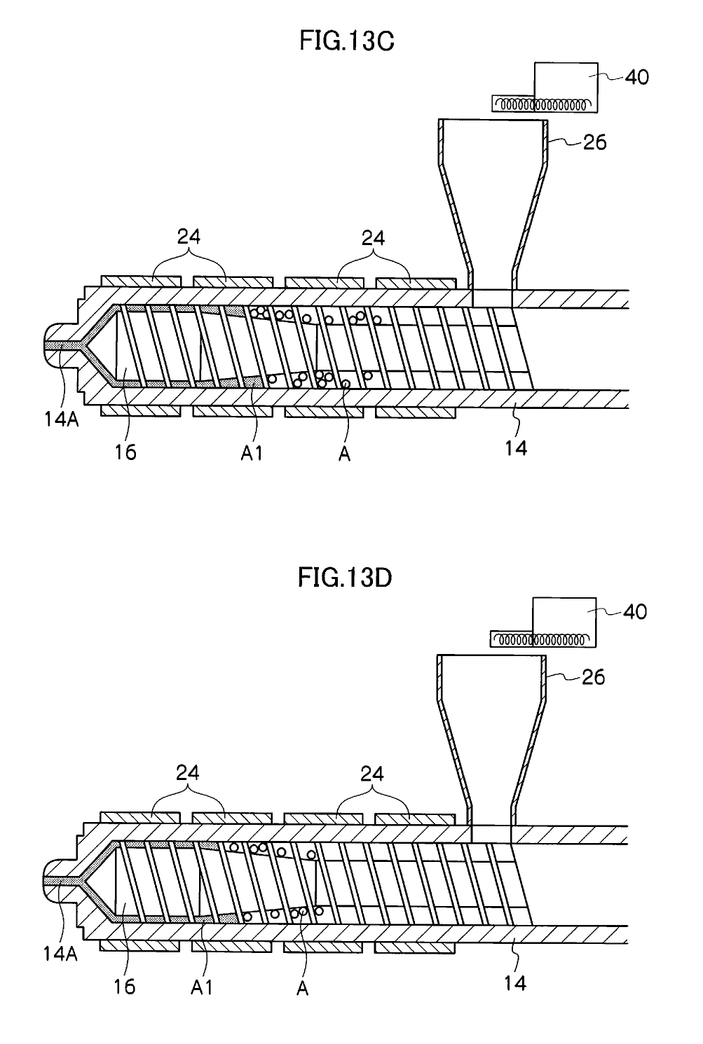

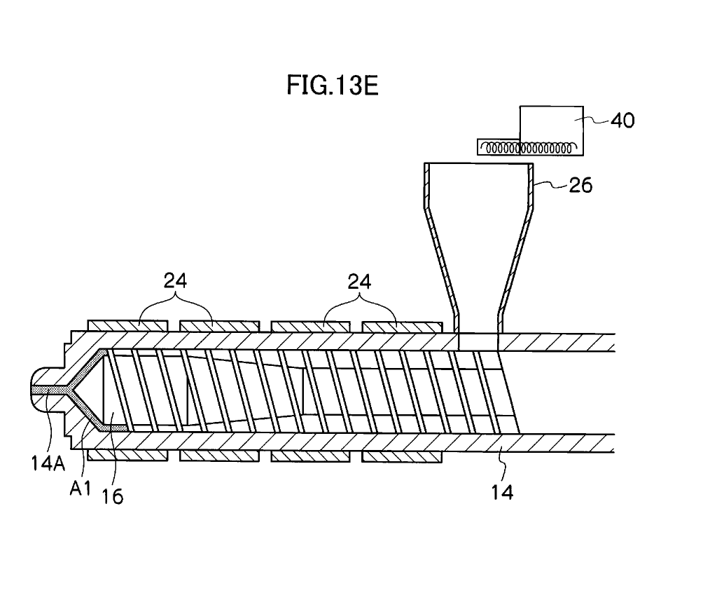

In this respect, with reference to FIGS. 13A to 13E, differences between “normal feeding”, “hungry feeding”, and “scattering feeding” in the presently disclosed subject matter will be described.

FIGS. 13A to 13E illustrate an example of a resin pellet as a molding material, reference character A designates the pellet, and reference character A1 designates molten resin that is the melted pellet.

### (Measuring Step)

Generally, plasticization performed in a measuring step in injection molding is such that the pellet A in the cylinder 14 is conveyed forward by the screw 16, and uniformly melted by heat transferred from the heater 24 outside the cylinder 14 and frictional heat (shear energy) between pellets A, and a preset constant amount of molten resin A1 is stored in the tip of the cylinder 14.

Specifically, when the screw 16 is rotated and the molten resin A1 starts to be stored in the tip of the cylinder 14, the screw 16 is retracted by pressure of the pellet A itself successively fed by the rotation of the screw 16 unless the molten resin A1 leaks from the tip. In this case, an amount of fed pellet A increases with increasing speed of the rotation (with increasing rotation speed) of the screw 16, and a speed of retraction of the screw 16 increases.

Thus, if a signal to stop the rotation of the screw is provided to a preset constant amount of stroke position (measurement set position), the retraction of the screw 16 is stopped in the position. This is the measuring step.

Thus, with the same material and under the same condition, a time to reach the preset constant amount of stroke position, that is, a time to complete measurement is substantially constant with a constant rotational speed of the screw 16.

When the rotational speed of the screw 16 increases, a feeding amount of the pellet A increases, thereby reducing the time to reach the same stroke position, that is, the time to complete measurement.

Based on the above descriptions, the differences between “normal feeding”, “hungry feeding”, and “scattering feeding” in the presently disclosed subject matter will be compared.

### (Normal Feeding)

First, “normal feeding” in which the pellet A is accumulated in the hopper 26 mounted to the injection molding apparatus will be described. A feeding amount of the pellet A into the hopper 26 can be adjusted using the volumetric feeder 40 (volumetric feeding device). Before injection molding is started, the hopper 26 is filled with the pellet A. A general state of the pellet A in a thread groove in the screw 16 or the hopper 26 is shown in FIG. 13A (a conceptual view with a valve or the like omitted).

As is apparent from FIG. 13A, the thread groove in the screw 16 is always filled with the pellet A or the molten resin A1 that is the melted molding material, and a force for the screw 16 to feed the pellet A forward is always generated, and measurement is completed in a short time. Thus, the level of the pellet A stored in the hopper 26 is gradually reduced by consumption of the pellet A.

When the level of the pellet A is reduced to a lower end of the hopper 26 (a position H in FIG. 13A), the pellet A is fed into the hopper 26 at a feeding speed higher than a consumption speed of pellet A consumed in an injection molding cycle so that the hopper 26 is again filled with the pellet A. Thus, in the normal feeding, consumption and filling of the pellet A in the hopper 26 are repeated with reference to the position H in FIG. 13A.

### (Hungry Feeding)

Next, “hungry feeding” will be described.

From a state where the injection molding is continued in the “normal feeding” state, the pellet A is gradually consumed. When the pellet A reaches the lower end (the position H in FIG. 13A) of the hopper 26, the pellet A is added, and the storage level in the hopper 26 is again increased, which is the “normal feeding”.

However, in the hungry feeding, even if the pellet A reaches the lower end of the hopper 26 (the position H in FIG. 13A), the pellet A is not added to the hopper 26 but injection molding is continued for a while. Then, the level of the pellet A is further reduced from the lower end of the hopper 26, and reaches under the inlet port 25 (a position L in FIG. 13A). In this state, the volumetric feeder 40 feeds the pellet A in an amount equal to an average consumption amount of the pellet A to the hopper 26. Specifically, the average consumption amount (average consumption speed) of the pellet A is made equal to an average feeding amount (average feeding speed) of the pellet A. Thus, a rear end position of the pellet A in the cylinder 14 reaches a position shown in FIG. 13B according to intermittent consumption of the pellet A. Thus, when the state of the inlet port 25 is observed from the side of the hopper 26, the pellet A is sometimes visible. In other words, the screw 16 is sometimes visible (can be seen in spots). This is the hungry feeding state.

Thus, in the hungry feeding, the pellet A sometimes does not exist in the hopper 26 and in a feeding path to under the inlet port 25, but when the pellet A is fed into the hopper 26, the pellet A is continuous with the rear end position of the pellet A in the cylinder 14. Specifically, the molten resin A1 stored in the tip of the screw 16 is always continuously fed in a required amount by the pellet A in the thread groove in the screw. In other words, a state where a sufficient amount of pellet A required for retraction of the screw 16 can be fed is maintained as in the “normal feeding”.

The “hungry feeding” differs from the “normal feeding” in that a gap portion from the screw 16 to the hopper 26 is increased as described above, and thus water or cracked gas can be easily released from the inlet port 25 to the outside, which is a problem in the hungry feeding.

### (Scattering Feeding)

Then, the “scattering feeding” in the presently disclosed subject matter will be described.

First, in view of the state in FIG. 13B in the hungry feeding, feeding of the pellet A is once stopped in this state in the “scattering feeding”. Then, the pellet A or the molten resin A1 in the thread groove in the screw 16 are further consumed by injection molding, and enter states in FIG. 13C or 13D, and even if the screw 16 is rotated, the resin pellet and the molten resin are not easily fed forward. Specifically, the feeding zone, or a section from the feeding zone to the compression zone is not filled with the pellet A. In fact, in FIG. 13C, when the loose-tight state (sparse-dense state) of the molding material inside the cylinder 14 was observed from the inlet port 25 after removing the hopper 26, the state of the molding material was loose (sparse) and there was no sign indicating the fullness of molding material.

With a large amount of the pellet A or the molten resin A1 filled into the thread groove in the screw 16, the pellet A or the molten resin A1 is easily fed forward by a force of the thread groove. However, in the “scattering feeding”, an extremely small amount of molding material exists in the thread groove, and even if the screw 16 is rotated, the pellet A or the molten resin A1 is not easily fed forward. In a state in FIG. 13E, since no molding material is fed forward, naturally, no back pressure is applied on the screw 16, and thus, the screw 16 does not retract anymore. Hence, it is required that at least inside the thread groove of the screw 16 is filled with the molding material to some extent. Then, the screw 16 does not stop rotation until the screw 16 is retracted to a certain stroke position, and thus addition of the pellet A is waited while the screw 16 is rotated to knead the pellet A or the molten resin A1 in the thread groove. Specifically, in the “scattering feeding”, at the start of injection molding, a state where the pellet A or the molten resin A1 is not easily fed forward even if the screw 16 is rotated, that is, a state where at least the feeding zone among the feeding zone, the compression zone, and the measuring zone is not filled with the pellet A as in FIGS. 13C and 13D is formed. In this state, the pellet A is added from the volumetric feeder 40 to the hopper 26 at a feeding speed lower than that for the average consumption speed of the pellet A in the “normal feeding”. Thus, the pellet A or the molten resin A1 is filled into the thread groove in the screw 16 to gradually increase back pressure in the tip of the screw, and the screw 16 is slowly retracted. Thus, in the “scattering feeding”, a state where the addition of the pellet A is waited is continued although the screw 16 is rotated, and thus a long measuring time can be taken.

The position of filling of the pellet A that allows retraction of the screw 16 differs depending on injection molding conditions, particularly, back pressure, screw shapes, or properties of the molding material, but the presently disclosed subject matter can be achieved in any states from FIG. 13C through FIG. 13D to FIG. 13E. The amount of the pellet A at least in the feeding zone needs to be considerably reduced, and this changes the degree of pressing of the pellet A or the molten resin A1 in the compression zone. This can reduce excessive shear in the compression zone, and prevent a substantial temperature from significantly exceeding a control temperature to deteriorate the pellet A. Also when the molding material contains a pellet and powder, kneading dispensability of the powder is prevented from being reduced by a rapid reduction in resin viscosity.

### [Test C]

Next, a specific example of the injection molding method of the second embodiment of the presently disclosed subject matter will be described by Test C.

### [Molding Material]

| | | |
|---|---|---|
| polylactic resin (pellet) . . . TERRAMAC TE7000 | 100 | parts by |
| produced by UNITIKA. LTD. | | weight |
| ammonium polyphosphate flame retardant (powder) . . . | 40 | parts by |
| AP423 produced by Clariant | | weight |
| compatibilizing agent (phosphazene derivative) | 10 | parts by |
| (powder) . . . Rabitle FP110 produced by FUSHIMI | | weight |
| Pharmaceutical Co., Ltd. | | |
| antioxidant (powder) . . . Irganox 245 produced by | 0.5 | parts by |
| Chiba Specialty Chemicals Inc. | | weight |
| antihydrolytic agent (powder) . . . CARBODILITE | 3 | parts by |
| LA1 produced by Nisshinbo Chemical Inc. | | weight |
| elastomer (pellet) . . . METABLEN SRK200 produced | 15 | parts by |
| by MITSUBISHI RAYON CO., LTD. | | weight |

Among the materials, for the elastomer, melt extrusion of powder elastomer was previously performed and formed into a pellet for use.

Among the materials, the polylactic resin of a pellet and the elastomer in the shape corresponding to a pellet were previously dry blended in a pellet mixing tank 37B and used as a pellet material A. Bulk specific gravity of the pellet material A was 1.31.

The ammonium polyphosphate flame retardant, the compatibilizing agent, the antioxidant, and the antihydrolytic agent were previously dry blended in a powder mixing tank 35B and used as a powder material B. Bulk specific gravity of the powder material B was 0.83.

Further, the pellet material A was adjusted in shape to reduce bulk specific gravity to 1.10 and used as a pellet material A1.

### [Injection Molding Apparatus]

As an injection molding apparatus 10, a 150 t injection molding apparatus (SG150U) produced by Sumitomo Heavy Industries, Ltd. was used in the test. A material feeding device 34 having the configuration shown in FIG. 1 was used. A hopper 26 mounted to the injection molding apparatus 10 was not a large hopper that stores general materials, but a hopper having a small capacity was used. An optical upper limit level sensor 140 and lower limit level sensor 143 were mounted to the hopper 26, a controller 139 controlled a feeding amount of one injection shot of each of a powder measuring feeder 135C and a pellet measuring feeder 137C so that a storage amount of the molding material stored in the hopper 26 is between the upper limit level sensor 140 and the lower limit level sensor 143. The feeding amount was controlled by driving on/off the powder measuring feeder 135C and the pellet measuring feeder 137C.

A mold 30 that can simultaneously perform injection molding of a Charpy test piece and a UL test piece (thickness of 1.6 mm) was set in the injection molding apparatus 10. Heater temperatures of the injection molding apparatus were set to 195° C., 195° C., 190° C., 180° C., and 30° C. from the side of a nozzle 12. An injection amount of one shot was set to 25 g. Although the injection molding apparatus 10 includes three heaters 24 in FIG. 8, the injection molding apparatus employed in this Test C. In addition, in this test, the molding material was fed into the cylinder 14 by self-weight of the molding material without using a measurement control feeder 141 of a table feeder type provided in the hopper 26.

For test pieces of 20 samples continuously molded from eleventh to thirtieth shots under injection molding conditions of Examples 1 to 4 and Comparative examples 1 to 3 described later, four items: “weight (variations) of test piece”, “Charpy impact”, “flammability”, and “dispensability” were evaluated.

Test methods for the evaluations of “weight (variations) of test piece”, “Charpy impact”, “flammability”, and “dispensability” are as described below.

### (Weight (Variations) of Test Piece)

When standard deviation of weights of 20 samples measured was σ, standard deviation σ less than 0.08 was acceptable (Pass), and standard deviation σ of 0.08 or more was unacceptable (Fail).

### (Charpy Impact Test)

The Charpy impact test was the same as in Tests A and B.

### (Flammability Test: UL94-V)

The flammability test was the same as in Tests A and B in the first embodiment, flame retardancy of V-1 or more was acceptable (Pass) and flame retardancy of V-2 or less was unacceptable (Fail).

### (Dispersibility Test)

The dispensability test was the same as in Tests A and B in the first embodiment.

### (Determination)

When the four evaluation items were all acceptable, it was determined to be acceptable (Pass), and when even one of the evaluation items was unacceptable, it was determined to be unacceptable (Fail).

### [Injection Molding Conditions and Test Results of Examples and Comparative Examples]

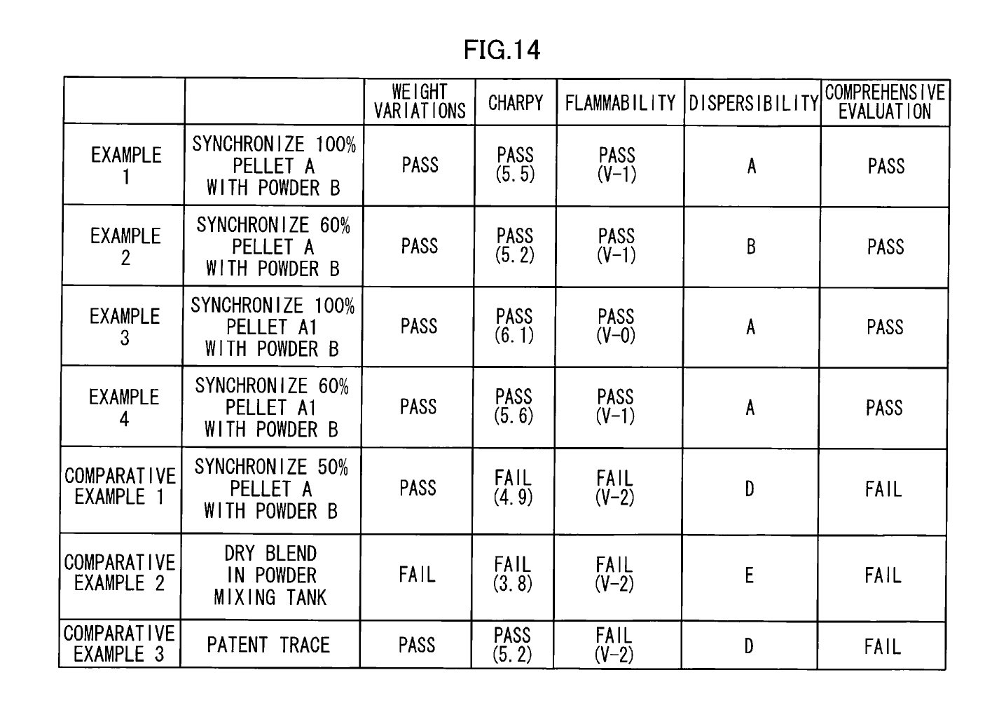

A table in FIG. 14 shows injection molding conditions and test results of examples and comparative examples in Test C.

### Example 1

In Example 1, the pellet material A and the powder material B were fed into the hopper 26 so as to be synchronized 100% by the pellet measuring feeder 137C and the powder measuring feeder 135C. As a result, “weight (variations) of test piece” was acceptable and “dispensability” was A as the highest evaluation, and it was found that the pellet material A and the powder material B were uniformly mixed. As a result of uniform mixing, the evaluation of both “Charpy impact” and “flammability” was acceptable, and a comprehensive evaluation was also acceptable.

### Example 2

In Example 2, the pellet material A and the powder material B were fed into the hopper 26 so as to be synchronized 60% by the pellet measuring feeder 137C and the powder measuring feeder 135C. As a result, the evaluation of “dispensability” and the value of “Charpy impact” were slightly lower than those in Example 1 of 100% synchronization, but an acceptable level was obtained without any problem in quality.

### Example 3

In Example 3, the pellet material A1 and the powder material B were fed into the hopper 26 so as to be synchronized 100% by the pellet measuring feeder 137C and the powder measuring feeder 135C. As a result, as in Example 1, “weight (variations) of test piece” was acceptable and “dispensability” was A as the highest evaluation.

The evaluations of “Charpy impact” and “flammability” were higher than those in Example 1 which was also in 100% synchronization. This was because a difference in bulk specific gravity between the pellet material A1 and the powder material B in Example 3 was lower than that between the pellet material A and the powder material B in Example 1.

### Example 4

In Example 4, the pellet material A1 and the powder material B were fed into the hopper 26 so as to be synchronized 60% by the pellet measuring feeder 137C and the powder measuring feeder 135C. As a result, the evaluation of “dispensability” and the value of “Charpy impact” were slightly lower than those in Example 3 of 100% synchronization, but an acceptable level was obtained without any problem in quality. Also, in Example 4, a difference in bulk specific gravity is lower than that in Example 2 which was also in 60% synchronization, and higher results were obtained in “dispensability” and the value of “Charpy impact” than those in Example 2.

### Comparative Example 1

In Comparative example 1, the pellet material A and the powder material B were fed into the hopper 26 so as to be synchronized 50% by the pellet measuring feeder 137C and the powder measuring feeder 135C. As a result, the evaluation of “weight (variations) of test piece” was acceptable, but the evaluation of “Charpy impact”, “flammability”, and “dispensability” were unacceptable or D, and a comprehensive evaluation was also unacceptable.

### Comparative Example 2

In Comparative example 2, the pellet material A and the powder material B were not separately dry blended in the pellet mixing tank 137B and the powder mixing tank 135B as in Examples 1 to 4 and Comparative examples 1, but together dry blended in the powder mixing tank 135B and fed into the hopper 26 by the powder measuring feeder 135C. As a result, the four evaluation items were all unacceptable or D, and the result of each item was lower than that in Comparative example 1. In particular, the evaluation of “dispensability” was a lowest result of E.

### Comparative Example 3

In Comparative example 3, a test was performed according to Japanese Patent Application Laid-Open No. 2005-319813. Specifically, a volumetric feeder F3 by TOYO SEIKI SEISAKU-SHO, LTD. was manually operated on/off, and the molding material was fed into the cylinder by a feeding method in Japanese Patent Application Laid-Open No. 2005-319813. As a result, the evaluation of Comparative example 3 was higher than those of other Comparative examples 1 and 2, but lower than those of Examples 2 and 4 of 60% synchronization, and a comprehensive evaluation was unacceptable. In particular, for dispensability with the evaluation of D, in Comparative example 3, an additive was continuously fed in the measuring step and also in the injection step and the dwelling step where the screw is not rotated after the measuring step, and this may affect dispensability.

### [Consideration of Results of Test C]

As is apparent from the test results, in order to uniformly mix the pellet material A (or A1) and the powder material B when directly feeding the pellet material A (or A1) and the powder material B into the cylinder of the injection molding apparatus for injection molding, it is important to satisfy the following three conditions.

(1) One injection shot of each of the materials is fed into the hoppers using separate measuring feeders.
(2) The materials are fed so that feeding time periods from the start to the finish of feeding are synchronized 60% or more.
(3) The feeding is finished within the measuring time in the measuring step of the injection molding cycle.

What is claimed is:

1. An injection molding method including a measuring step for measuring an amount of the molding material by storing a molding material fed into a cylinder of an injection molding apparatus in a tip of the cylinder by rotation of a screw and stopping a rotation of the screw after the screw is retracted to a measurement set position by a pressure from the stored molding material itself, wherein
the measuring step comprises:
setting a back pressure to be applied on the screw, to a predetermined value;
setting a rotation speed of the screw to a constant rotation speed within a range of 50 to 300 rpm; and
adjusting a feeding speed of the molding material fed into the cylinder so that a measuring time becomes twice SN seconds or more and 180 seconds or less, the SN indicating a measuring time in a normal feeding method in which the molding material is fed from an inlet port into the cylinder to fill the cylinder by self-weight of the molding material in accordance with a material feeding capacity of the rotation speed of the screw,
whereby the measuring time is controlled irrespective of the rotation speed of the screw and the back pressure set value.

2. The injection molding method according to claim 1, wherein
when an inside of the cylinder is divided into three zones: a feeding zone, a compression zone, and a measuring zone in this order from the inlet port of the molding material, a space before at least the compression zone is not filled with the molding material.

3. The injection molding method according to claim 2, wherein
at a start of injection molding, a state where the space before at least the compression zone is not filled with the molding material is created, and in this state, the molding material is added from a volumetric feeding device at a feeding speed lower than that for an average consumption speed of the molding material in the normal feeding method.

4. The injection molding method according to claim 3, wherein
the molding material contains base resin and an additive, at least one of the base resin and the additive is powder, and the molding material not pelletized is directly fed into the cylinder.

5. The injection molding method according to claim 1, wherein a small amount of the molding material is continuously fed into the cylinder to adjust the feeding speed.

6. The injection molding method according to claim 1, wherein the molding material is intermittently fed into the cylinder to adjust the feeding speed.

7. The injection molding method according to claim 1, wherein
the molding material contains at least a powder material and a pellet material among the powder material, the pellet material, and a liquid material, and
one injection shot of each of the materials is fed into the cylinder using separate measuring feeders in a manner that feeding time periods from a start to a finish of feeding are synchronized 60% or more, and the feeding is finished within a measuring time in the measuring step of the injection molding cycle.

8. An injection molding method in which a molding material containing at least a powder material and a pellet material among the powder material, the pellet material and a liquid material is directly fed into a cylinder of an injection molding apparatus for injection molding, the injection molding method comprising:
feeding one injection shot of each of the materials into the cylinder using separate measuring feeders in a manner that feeding time periods from a start to a finish of feeding are synchronized 60% or more; and
finishing the feeding within a measuring time in the measuring of an injection molding cycle.

9. The injection molding method according to claim 1, wherein the measuring time is controlled in accordance with a required kneading time of the molding material.

10. The injection molding method according to claim 8, wherein the measuring time is controlled in accordance with a required kneading time of the molding material.

11. The injection molding method according to claim 1, wherein
an injection molding cycle includes the measuring step of the molding material, a mold clamping step, an injection step of molten resin from the cylinder to the mold, a dwelling step of dwelling pressure in the mold, a cooling step of cooling the mold, and a releasing step of releasing the mold to remove a molded product, and
the measuring time is controlled according to a time from a start of the cooling step to a finish of the releasing step of the injection molding cycle.

12. The injection molding method according to claim 8, wherein
an the injection molding cycle includes the measuring step of the molding material, a mold clamping step, an injection step of molten resin from the cylinder to the mold, a dwelling step of dwelling pressure in the mold, a cooling step of cooling the mold, and a releasing step of releasing the mold to remove a molded product, and
the measuring time is controlled according to a time from a start of the cooling step to a finish of the releasing step of the injection molding cycle.

13. The injection molding method according to claim 1, wherein a ratio of the powder in the molding material is 30% by weight or more.

14. The injection molding method according to claim 8, wherein a ratio of the powder in the molding material is 30% by weight or more.

15. The injection molding method according to claim 1, wherein the molding material contains a base resin and an additive, the base resin is at least one of polylactic resin and cellulose resin, and the additive is at least one of flame retardant and fiber.

16. The injection molding method according to claim 8 wherein the molding material contains a base resin and an additive, the base resin is at least one of polylactic resin and cellulose resin, and the additive is at least one of flame retardant and fiber.
